(19) United States
(12) Patent Application Publication
(10) Pub. No.: US 2025/0208385 A1
(43) Pub. Date: Jun. 26, 2025

(54) OPTICAL SYSTEM, VEHICLE-MOUNTED CAMERA AND VEHICLE

(71) Applicant: Ningbo Sunny Automotive Optech Co., Ltd, Ningbo City (CN)

(72) Inventors: Qiansen XIE, Ningbo City (CN); Bo YAO, Ningbo City (CN); Yifeng WANG, Ningbo City (CN); Siwei HUANG, Ningbo City (CN)

(21) Appl. No.: 18/987,366

(22) Filed: Dec. 19, 2024

(30) Foreign Application Priority Data
Dec. 21, 2023 (CN) 202311776911.9

(51) Int. Cl. G02B 13/18

(52) U.S. Cl. CPC G02B 13/18

(57) ABSTRACT

An optical system, a vehicle-mounted camera, and a vehicle are provided. The optical system is applied to a vehicle, including: a lens group, including a plurality of lenses disposed sequentially along an optical axis from an object side to an image side; and a compensating lens, at least one of an object-side surface or an image-side surface of the compensating lens being a free-form surface; where, the free-form surface of the compensating lens is adapted to be disposed on an inner side of a windshield of the vehicle, such that the optical system and the windshield form a corrected optical system, and an MTF value of the corrected optical system is within a preset range.

### CROSS-REFERENCE TO RELATED APPLICATIONS

This application claims the priority from Chinese Patent Application No. 202311776911.9, filed in the National Intellectual Property Administration (CNIPA) on Dec. 21, 2023, the contents of which are hereby incorporated by reference in their entirety.

### TECHNICAL FIELD

The present disclosure relates to the field of optical devices, in particular to an optical system and a vehicle-mounted camera and a vehicle including the optical system.

### BACKGROUND

With the development of intelligent vehicles, front-view lens assemblies are more and more widely used, for example, identifying road conditions ahead, pedestrian traffic, traffic lights, etc. through a front-view lens assembly during travelling of a vehicle. However, due to the existence of a windshield having curvature on the object side of the front-view lens assembly, an irregular astigmatism generated by the windshield leads to degradation in comprehensive resolution of the front-view camera. A current mainstream solution is: adding a prism on the windshield to improve the resolution of the front-view camera. However, this solution has the following problems:
1. The solution of using a prism to improve the resolution is expensive, bulky and affects aesthetics of the windshield;
2. The solution of using a prism to improve the resolution is only applicable to matching a single lens assembly, and cannot be applied to a combination of multiple lens assemblies; and
3. The windshield is a free-form surface that generates an irregular astigmatism, the solution of using a prism to improve the resolution cannot completely correct the irregular astigmatism.

### SUMMARY

Implementations proposed in the present disclosure may solve or partially solve the problem of: the windshield affecting the astigmatism and a field curvature of the front-view camera thus resulting in degradation in the comprehensive resolution of the lens assembly, as proposed in the above background or other deficiencies in the related art.

In an aspect, implementations of the present disclosure provide an optical system, the optical system including: a lens group, including a plurality of lenses disposed sequentially along an optical axis from an object side to an image side; and a compensating lens, at least one of an object-side surface or an image-side surface of the compensating lens being a free-form surface; where, the free-form surface of the compensating lens is adapted to be disposed on an inner side of a windshield of the vehicle, such that the optical system and the windshield form a corrected optical system, and an MTF value of the corrected optical system is within a preset range.

In an implementation, an MTF value of the corrected optical system for optical path at at least one field-of-view in a portion below the optical axis is greater than or equal to 40% @60 lp/mm.

In an implementation, the MTF value of the corrected optical system for the optical path at the at least one field-of-view in the portion below the optical axis is greater than or equal to 45% @60 lp/mm.

In an implementation, an MTF value of the corrected optical system for optical path at a target field-of-view is greater than an MTF value of the optical system for optical path at the target field-of-view, where, the optical path at the target field-of-view is optical path at at least one field-of-view in a portion below the optical axis.

In an implementation, the MTF value of the corrected optical system for the optical path at the target field-of-view is improved by at least 5%, relative to the MTF value of the optical system for the optical path at the target field-of-view.

In an implementation, the MTF value of the corrected optical system for the optical path at the target field-of-view is improved by at least 10%, relative to the MTF value of the optical system for the optical path at the target field-of-view.

In an implementation, the free-form surface is an upper-lower asymmetric free-form surface.

In an implementation, the free-form surface is an upper-lower asymmetric and left-right asymmetric free-form surface.

In an implementation, a maximum thickness d of the compensating lens in a direction parallel to the optical axis, and a length TTL in a direction of the optical axis from a first lens of the lens group to an image plane of the optical system, satisfy: d/TTL≤⅓.

In an implementation, a direction parallel to the optical axis is defined as a Z-axis direction, a direction perpendicular to the Z-axis and lying in a meridian plane is defined as a Y-axis direction, and a direction perpendicular to the Z-axis and lying in a sagittal plane is defined as an X-axis direction, where in a YZ plane, the free-form surface of the compensating lens comprises a first area located above the optical axis and a second area located below the optical axis, an approximate radius of curvature R(+D) of the first area of the free-form surface located above the optical axis and an approximate radius of curvature R(−D) of the second area of the free-form surface located below the optical axis satisfy: R(+D)/R(−D)≥0.1.

In an implementation, the approximate radius of curvature R(+D) of the first area of the free-form surface located above the optical axis and the approximate radius of curvature R(−D) of the second area of the free-form surface located below the optical axis satisfy: R(+D)/R(−D)≥1.1.

In an implementation, in the YZ plane, a connecting line of effective radius vertices of the free-form surface of the compensating lens located above and below the optical axis has an angle of inclination of less than or equal to 5° relative to a plane perpendicular to the optical axis.

In an implementation, an approximate radius of curvature Rx in the X-axis direction of the free-form surface in an XZ plane, and an approximate radius of curvature Ry in the Y-axis direction of the free-form surface in the YZ plane, satisfy: Rx/Ry≥0.5.

In an implementation, an approximate radius of curvature Rx in the X-axis direction of the free-form surface in an XZ plane, and an approximate radius of curvature Ry in the Y-axis direction of the free-form surface in the YZ plane, satisfy: Rx>Ry.

In an implementation, an effective light-gathering diameter D of the free-form surface of the compensating lens, and a maximal aperture T of a lens adjacent to the compensating lens satisfy: D/T≤6; where D=\sqrt{Dx²+Dy²}, Dx is an effective light-gathering diameter of the free-form surface of the compensating lens in the X-axis direction, and Dy is an effective light-gathering diameter of the free-form surface of the compensating lens in the Y-axis direction.

In an implementation, the plurality of lenses comprise an optical filter and a protective glass.

In an implementation, the compensating lens is disposed between the optical filter and the protective glass.

In an implementation, the compensating lens is disposed on an object-side surface or an image-side surface of the optical filter, or is disposed on an object-side surface or an image-side surface of the protective glass.

In an implementation, the free-form surface of the compensating lens is asymmetrically convex relative to the optical axis.

In an implementation, the free-form surface of the compensating lens is convex in a half-droplet shape.

In an implementation, the compensating lens is disposed on an object side or an image side of any one of the lenses in the lens group.

In an implementation, the compensating lens is prepared through at least one of: nanoimprinting, mould processing, or lamination.

In an implementation, a maximal aberration value generated by the windshield of the vehicle is L1, the free-form surface of the compensating lens is configured to: compensate for an astigmatism generated by the windshield of the vehicle, such that a maximal aberration value on the image plane of the corrected optical system is L1′, where L1′≤½L1.

In another aspect, an implementation of the present disclosure also provides a vehicle-mounted camera, the vehicle-mounted camera including: the above optical system, and a photosensitive component circuit and a control component for converting an optical image formed by the optical system into an electrical signal.

In yet another aspect, an implementation of the present disclosure also provides a vehicle, the vehicle including: a windshield; and the above optical system, where, the optical system is disposed on an inner side of the windshield, such that the optical system and the windshield form a corrected optical system.

The optical system, the vehicle-mounted camera, and the vehicle provided according to at least one of the above implementations of the present disclosure, the optical system includes a compensating lens having a free-form surface, improves an astigmatism and a field curvature by the free-form surface of the compensating lens, improves resolution of the optical system, and solves the problem of resolution degradation of the optical system due to the windshield, such that the optical system has at least one of the following beneficial effects:
1. The optical system provided in implementations of the present disclosure has a small-volume compensating lens, and the optical system has only one additional compensating lens having a free-form surface, compared to conventional lens assemblies.
2. The compensating lens of the optical system provided in implementations of the present disclosure may be separately placed on a stand-alone lens assembly, so that different lens assemblies do not affect each other, and the resolution of a module having a combination of multiple lens assemblies may be improved.
3. The free-form surface of the compensating lens of the optical system provided in implementations of the present disclosure may be designed with an upper-lower asymmetric and left-right asymmetric surface to correct for an irregular astigmatism in each field-of-view direction.

### BRIEF DESCRIPTION OF THE DRAWINGS

By reading detailed descriptions of non-limiting embodiments with reference to the following accompanying drawings, other features, objectives and advantages of the present disclosure will become more apparent:

FIG. 1A is a defocus curve graph of an optical system when there is a windshield on the object side of the optical system, according to an embodiment of the present disclosure;

FIG. 1B is a schematic structural diagram of an optical system according to an embodiment of the present disclosure;

FIG. 1C is a sectional view of a free-form surface of a compensating lens in a YZ plane;

FIG. 1D is a diagram of surface sagittal height distribution of a free-form surface of a compensating lens;

FIG. 1E is a sectional view of a free-form surface of a compensating lens in a YZ plane;

FIG. 1F illustrates a sectional view of a free-form surface of a compensating lens in a XZ plane;

FIG. 2A is a schematic structural diagram of an optical system in Embodiment 1 of the present disclosure when a compensating lens is not provided;

FIG. 2B is a defocus curve graph of the optical system in Embodiment 1 of the present disclosure when a compensating lens is not provided and there is no windshield on an object side thereof;

FIG. 2C is a schematic diagram of a relative position of the optical system in Embodiment 1 of the present disclosure when a compensating lens is not provided and a windshield;

FIG. 2D is a defocus curve graph of the optical system in Embodiment 1 of the present disclosure when a compensating lens is not provided and there is a windshield on an object side thereof;

FIG. 2E is a schematic structural diagram of the optical system in Embodiment 1 of the present disclosure when a compensating lens is provided and there is a windshield on an object side thereof;

FIG. 2F is an enlarged view of the compensating lens in FIG. 2E;

FIG. 2G is a defocus curve graph of the optical system in Embodiment 1 of the present disclosure when a compensating lens is provided and there is a windshield on an object side thereof;

FIG. 2H illustrates a defocus curve graph of the optical system in Embodiment 1 of the present disclosure when a compensating lens is provided and there is no windshield on an object side thereof;

FIG. 3A is a schematic structural diagram of an optical system in Embodiment 2 of the present disclosure;

FIG. 3B is an enlarged view of the compensating lens in FIG. 3A;

FIG. 3C is a defocus curve graph of the optical system in Embodiment 2 of the present disclosure when a compensating lens is not provided and there is a windshield on an object side thereof;

FIG. 3D is a defocus curve graph of the optical system in Embodiment 2 of the present disclosure when a compensating lens is provided and there is a windshield on an object side thereof;

FIG. 4A is a schematic structural diagram of an optical system in Embodiment 3 of the present disclosure;

FIG. 4B is an enlarged view of the compensating lens in FIG. 4A;

FIG. 4C is a defocus curve graph of the optical system in Embodiment 3 of the present disclosure when a compensating lens is not provided and there is a windshield on an object side thereof;

FIG. 4D is a defocus curve graph of the optical system in Embodiment 3 of the present disclosure when a compensating lens is provided and there is a windshield on an object side thereof;

FIG. 5A is a schematic structural diagram of an optical system in Embodiment 4 of the present disclosure;

FIG. 5B is an enlarged view of the compensating lens in FIG. 5A;

FIG. 5C is a defocus curve graph of the optical system in Embodiment 4 of the present disclosure when a compensating lens is not provided and there is a windshield on an object side thereof;

FIG. 5D is a defocus curve graph of the optical system in Embodiment 4 of the present disclosure when a compensating lens is provided and there is a windshield on an object side thereof;

FIG. 6A is a schematic structural diagram of an optical system in Embodiment 5 of the present disclosure;

FIG. 6B is an enlarged view of the compensating lens in FIG. 6A;

FIG. 6C is a defocus curve graph of the optical system in Embodiment 5 of the present disclosure when a compensating lens is not provided and there is a windshield on an object side thereof;

FIG. 6D is a defocus curve graph of the optical system in Embodiment 5 of the present disclosure when a compensating lens is provided and there is a windshield on an object side thereof;

FIG. 7A is a schematic structural diagram of an optical system in Embodiment 6 of the present disclosure;

FIG. 7B is an enlarged view of the compensating lens in FIG. 7A;

FIG. 7C is a defocus curve graph of the optical system in Embodiment 6 of the present disclosure when a compensating lens is not provided and there is a windshield on an object side thereof;

FIG. 7D is a defocus curve graph of the optical system in Embodiment 6 of the present disclosure when a compensating lens is provided and there is a windshield on an object side thereof;

FIG. 8A is a schematic structural diagram of an optical system in Embodiment 7 of the present disclosure;

FIG. 8B is an enlarged view of the compensating lens in FIG. 8A;

FIG. 8C is a defocus curve graph of the optical system in Embodiment 7 of the present disclosure when a compensating lens is not provided and there is a windshield on an object side thereof; and

FIG. 8D is a defocus curve graph of the optical system in Embodiment 7 of the present disclosure when a compensating lens is provided and there is a windshield on an object side thereof.

FIG. 9A, FIG. 10A and FIG. 11A are schematic structural diagrams of three optical systems in Embodiment 8 of the present disclosure, respectively;

FIG. 9B, FIG. 10B and FIG. 11B are defocus curve graphs of the three optical systems in Embodiment 8 of the present disclosure when a compensating lens is provided and there is a windshield on an object side thereof, respectively;

FIG. 12A, FIG. 13A and FIG. 14A are schematic structural diagrams of three optical systems in Embodiment 9 of the present disclosure, respectively;

FIG. 12B, FIG. 13B and FIG. 14B are enlarged views of compensating lenses of the three optical systems in Embodiment 9, respectively;

FIG. 12C, FIG. 13C and FIG. 14C are defocus curve graphs of the three optical systems in Embodiment 9 of the present disclosure when a compensating lens is provided and there is a windshield on an object side thereof, respectively;

FIG. 12D is a schematic structural diagram of another optical system in Embodiment 9 of the present disclosure;

FIG. 15A, FIG. 16A, FIG. 17A, FIG. 18A, FIG. 19A, FIG. 20A, and FIG. 21A are schematic structural diagrams of seven optical systems in Embodiment 10 of the present disclosure, respectively;

FIG. 15B, FIG. 16B, FIG. 17B, FIG. 18B, FIG. 19B, FIG. 20B, and FIG. 21B are enlarged views of compensating lenses of the seven optical systems in Embodiment 10, respectively; and

FIG. 15C, FIG. 16C, FIG. 17C, FIG. 18C, FIG. 19C, FIG. 20C, and FIG. 21C are defocus curve graphs of the seven optical systems in Embodiment 10 of the present disclosure when a compensating lens is provided and there is a windshield on an object side thereof, respectively;

FIG. 22A is a schematic structural diagram of an optical system in Embodiment 11 of the present disclosure;

FIG. 22B is a defocus curve graph of the optical system in Embodiment 11 of the present disclosure when a compensating lens is provided and there is a windshield on an object side thereof; and

FIG. 22C illustrates a defocus curve graph of the optical system in Embodiment 11 of the present disclosure when a compensating lens is provided and there is no windshield on an object side thereof.

### DETAILED DESCRIPTION OF EMBODIMENTS

For a better understanding of the present disclosure, various aspects of the present disclosure will be described in more detail with reference to the accompanying drawings. It should be understood that the detailed description is merely an illustration for the exemplary implementations of the present disclosure, rather than a limitation to the scope of the present disclosure in any way. Throughout the specification, the same reference numerals designate the same elements. The expression “and/or” includes any and all combinations of one or more of the associated listed items.

In the accompanying drawings, the thicknesses, sizes and shapes of the components are slightly adjusted for the convenience of explanation. The accompanying drawings are illustrative only and are not drawn strictly to scale. For example, the thicknesses of the compensating lens and the windshield.

It should be further understood that the terms “comprise,” “comprising,” “having,” “include” and/or “including,” when used in the specification, specify the presence of stated features, elements and/or components, but do not exclude the presence or addition of one or more other features, elements, components and/or combinations thereof. In addition, expressions such as “at least one of,” when preceding a list of listed features, modify the entire list of features rather than an individual element in the list. Further, the use of “may,” when describing the implementations of the present disclosure, represents “one or more implementations of the present disclosure.” Also, the term “exemplary” is intended to refer to an example or illustration.

Unless otherwise defined, all terms (including technical and scientific terms) used herein have the same meaning as commonly understood by those of ordinary skill in the art to which the present disclosure belongs. It should be further understood that terms (e.g., those defined in commonly used dictionaries) should be interpreted as having a meaning that is consistent with their meaning in the context of the relevant art and will not be interpreted in an idealized or overly formal sense unless expressly so defined herein.

It should be noted that embodiments in the present disclosure and the features in the embodiments may be combined with each other on a non-conflict basis. Embodiments of the present disclosure are described in detail with reference to the accompanying drawings.

A front-view lens assembly equipped in an intelligent vehicle is usually disposed on the inner side of a windshield, and since the windshield is a glass having a free-form surface, an irregular astigmatism may be generated. After object-side light passes through the windshield, the light may be deflected by the windshield, resulting in a center optimal image plane and an edge optimal image plane not being on one plane, thus forming aberrations, that is, a large astigmatism may be generated in imaging. In a light-admitted area of the front-view lens assembly, in particular, an optical path below the optical axis, is deflected by the windshield. The optical path below the optical axis (i.e., the optical path formed by the light which enters the lens assembly through the portion below the optical axis) is farther away from a center field-of-view than the optical path above the optical axis, and thus has a greater field curvature astigmatism.

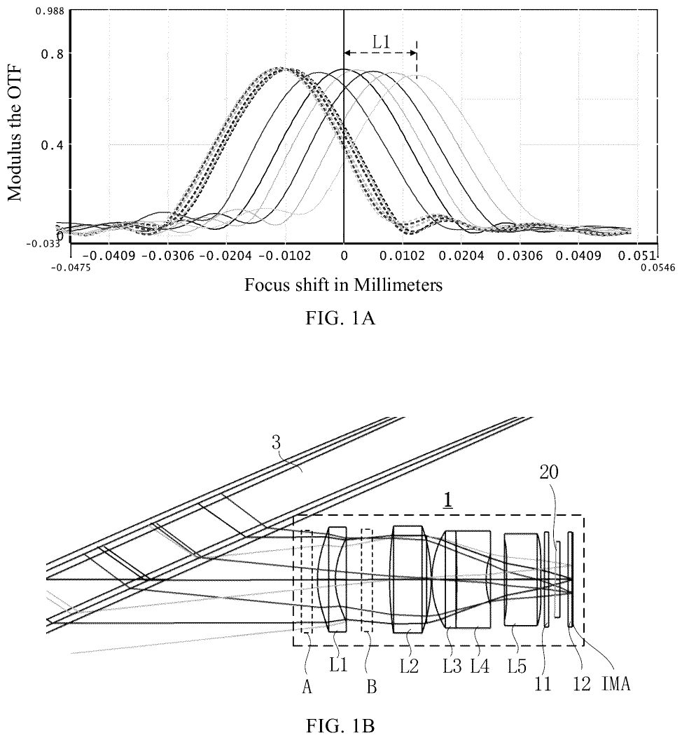

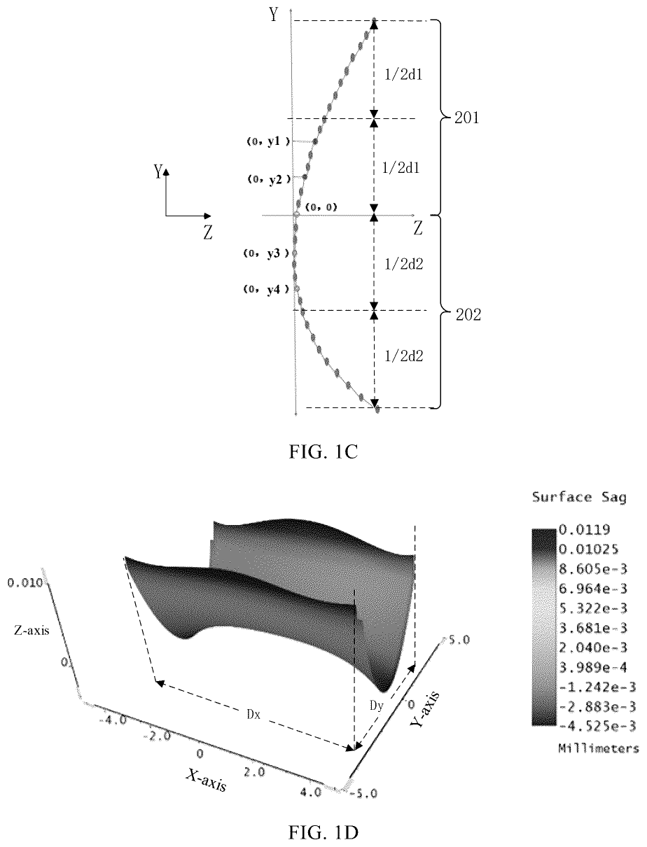

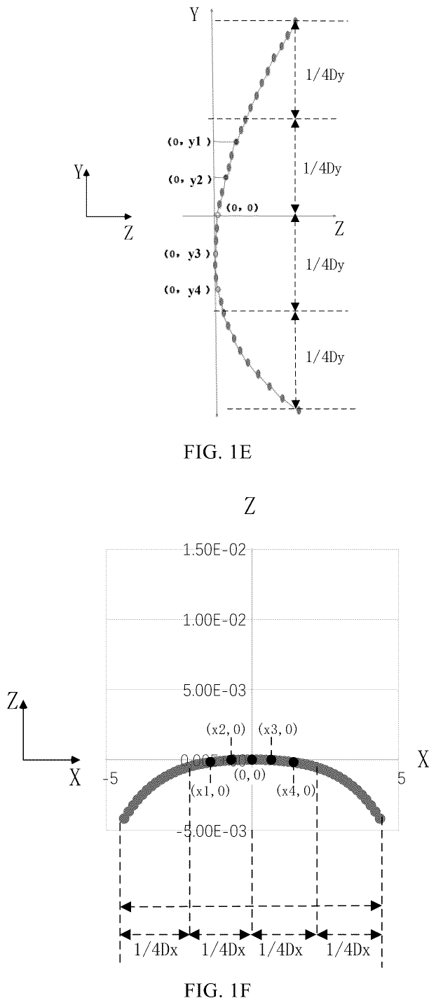

Exemplarily, FIG. 1A is a defocus curve graph of an optical system according to an embodiment of the present disclosure when a compensating lens is not provided and there is a windshield on an object side thereof, and in FIG. 1A, peak positions of defocus curves are scattered, shift of the focal points is severe, e.g., the maximal aberration value is L1.

In order to address the influence of the windshield on the astigmatism of the optical system, embodiments of the present disclosure provide an optical system, the optical system including a lens group and a compensating lens, at least one of an object-side surface or an image-side surface of the compensating lens being a free-form surface; where, the free-form surface of the compensating lens is adapted to be disposed on an inner side of a windshield of a vehicle, such that the optical system and the windshield form a corrected optical system, and an MTF value of the corrected optical system is within a preset range. Here, the free-form surface of the compensating lens is configured to: compensate for an astigmatism generated by the windshield of the vehicle, such that the MTF value of the optical system when a windshield is provided on the object side thereof is within the preset range, i.e., the MTF value of the corrected optical system formed by the optical system and the windshield together is within the preset range. For example, when a windshield is provided on the object side of the optical system, the MTF value of the corrected optical system for the optical path at at least one field-of-view in the portion below the optical axis is greater than or equal to 40% @60 lp/mm. In particular, the MTF value of the corrected optical system for the optical path at at least one field-of-view in the portion below the optical axis is greater than or equal to 45% @60 lp/mm. The optical system provided in embodiments of the present disclosure may present a good imaging quality when a windshield is provided on the object side thereof.

The unit of MTF (i.e., Modulation Transfer Function) is line pairs per millimetre (lp/mm). In embodiments of the present disclosure, the units of the MTF values in embodiments are different, for example, @60 lp/mm, @65 lp/mm, etc. However, those skilled in the art should understand that different lp/mm indicate results of testing at different spatial frequencies, and that the MTF value decreases gradually with the increase of lp/mm and the two tend to be linearly related. Generally, when the MTF value of the optical system is greater than 40% @120 lp/mm, the MTF value of the optical system is also greater than 40% @60 lp/mm.

It may be understood that the compensating lens of the optical system in embodiments of the present disclosure is configured to correct the irregular astigmatism generated by the windshield, in particular, since the windshield has a larger influence on the optical path at the field-of-view in the portion below the optical axis (i.e., the optical path formed by the light which enters the optical system at the field-of-view that is located below the optical axis) of the corrected optical system, the compensating lens may be set to focus on correcting the optical path at the field-of-view in the portion below the optical axis of the corrected optical system. The optical system in the present disclosure is optimally designed when there is a windshield on the object side thereof, and the corrected optical system has a good MTF value, referring to that a system formed by the optical system and the windshield together has a good MTF value. However, in the case where there is no windshield on the object side of the optical system, the optical system in embodiments of the present disclosure has a poor MTF value. For optical path at a target field-of-view, optical path at the target field-of-view may be optical path at at least one field-of-view in the lower portion of the optical axis, and an MTF value of the corrected optical system for the optical path at the target field-of-view is greater than an MTF value of the optical system for the optical path at the target field-of-view, and it may also be understood that, when the optical system in embodiments of the present disclosure is provided with a windshield on the object side thereof, the MTF value of the optical system for the optical path at least one field-of-view in the portion below the optical axis is greater than the MTF value when the windshield is not provided on the object side of the optical system.

In an exemplary embodiment, the MTF value of the corrected optical system for the optical path at the target field-of-view is improved by at least 5% relative to the MTF value of the optical system for the optical path at the target field-of-view, which may be understood as the MTF value of the optical system for the optical path at at least one field-of-view in the portion below the optical axis is improved by at least 5% when a windshield is provided on the object side of the optical system relative to when there is no windshield on the object side thereof. Further, the MTF value of the corrected optical system for the optical path at the target field-of-view is improved by at least 10% relative to the MTF value of the optical system for the optical path at the target field-of-view, which may be understood as the MTF value of the optical system for the optical path at at least one field-of-view in the portion below the optical axis is improved by at least 10% when a windshield is provided on the object side of the optical system relative to when there is no windshield on the object side thereof. The optical system provided in embodiments of the present disclosure may present a good imaging quality when a windshield is provided on the object side thereof.

It may be understood that the optical path at the field-of-view in the portion below the optical axis may eventually be projected to the upper part of the image plane (chip), in embodiments of the present disclosure, the MTF value for the optical path at at least one field-of-view located in the portion below the optical axis mentioned above during performing MTF actual measurement on the optical system, has been post-processed and converted, and refers to the MTF value for the optical path at a field-of-view actually located below the optical axis. That is, the field-of-view direction associated with the MTF in the present application document is the same as the field-of-view direction in practice.

FIG. 1B is a schematic structural diagram of an optical system 1 according to an embodiment of the present disclosure. As shown in FIG. 1B, a windshield 3 is disposed on an object side of the optical system 1, and the optical system 1 includes a plurality of lenses having refractive powers (a first lens L1 to a fifth lens L5), an optical filter 11, a protective glass 12, and an image plane IMA disposed sequentially along an optical axis from the object side to an image side. The optical system 1 further includes at least one compensating lens 20 having a free-form surface, and the compensating lens 20 is disposed on an optical path of light spreading, for compensating the irregular astigmatism caused by the windshield 3. In FIG. 1B, the compensating lens 20 is only exemplarily disposed between the optical filter 11 and the protective glass 12, but embodiments of the present disclosure do not limit a position and number of the compensating lens 20, and the position and number of the compensating lens 20 may be set according to actual needs.

In an exemplary embodiment, the compensating lens 20 may be disposed inside the lens group. The compensating lens 20 may be a stand-alone compensating device disposed between any two adjacent lenses without contacting any of the lenses, such as at the position B in FIG. 1B. The compensating lens 20 may also be fabricated on an object-side surface or an image-side surface of any one of the lenses of the lens group, for example, the compensating lens 20 may be disposed on a surface of the first lens L1 to the fifth lens L5, the optical filter 11, or the protective glass 12. In embodiments of the present disclosure, the plurality of lenses of the lens group may include lenses having refractive powers (e.g., the first lens L1 to the fifth lens L5), and may also include lenses not having refractive powers, for example, the optical filter 11 and the protective glass 12 may also be regarded as lenses not having refractive powers, and when the compensating lens is disposed on a surface of the optical filter 11 and/or the protective glass 12, it may be referred to as being disposed inside the lens group. Disposing the compensating lens 20 inside the lens group is conducive to a small volume of the entire system, facilitating assembling, at the same time, it may combine different cost requirements and performance requirements, and may flexibly adjust the number and position of the compensating lens 20 to realize astigmatism compensation.

In an exemplary embodiment, the compensating lens 20 may be disposed outside the lens group. The compensating lens 20 may be a stand-alone compensating device disposed on an object side or an image side of the lens group, such as at the position A in FIG. 1B, where the compensating lens 20 is disposed between the first lens L1 closest to the object side of the lens group and the windshield 3. As another example, based on the above mentioned: the protective glass 12 may also be regarded as a lens not having a refractive power in embodiments of the present disclosure, and the protective glass 12 also belongs to the lens group, therefore, when the compensating lens 20 is disposed between the protective glass 12 and the image plane 13 (or photosensitive chip), the compensating lens 20 may also be referred to as being disposed outside the lens group. Disposing the compensating lens 20 outside of the lens group facilitates matching different windshields, flexibly switching different compensating lenses 20 without changing the original structure of the lens assembly, and meeting low-cost requirements; at the same time, disposing the compensating lens 20 outside of the lens group is also conducive to controlling an effective light-gathering diameter and a thickness of the compensating lens 20, realizing miniaturization of the optical system, and facilitating assembling.

In an exemplary embodiment, the free-form surface of the compensating lens 20 is an upper-lower asymmetric free-form surface, further, the free-form surface of the compensating lens 20 may also be an upper-lower asymmetric and left-right asymmetric free-form surface. There are different sagittal heights and curvatures at different positions of the free-form surface of the compensating lens 20, which is conducive to realizing compensation for the irregular astigmatism caused by the windshield and ensuring clear imaging in each field-of-view.

According to the optical system provided in embodiments of the present disclosure, a thickness difference is formed between a center thickness and an edge thickness of the compensating lens, the optimal image planes are pulled onto one image plane, so as to improve the astigmatism caused by the windshield. In particular, in actual use, in combination with the details of the changes of the field curvature and the astigmatism caused by the windshield, the compensating lens having a free-form surface may be added at different positions to improve the astigmatism and the field curvature, and the entire system is small in volume, facilitates assembling, at the same time, combining with different costs and performance, a compensating structure (i.e., the free-form surface) of the compensating lens may be flexibly adjusted, to realize astigmatism compensation.

The applicant has found some qualitative laws of the compensating lens after a lot of experimental research, such as: 1) the closer the position of the compensating lens is to the photosensitive chip, the better a compensating effect is; 2) the smaller the angle of inclination of the windshield relative to a plane perpendicular to the optical axis is, the smaller the astigmatism it generates, and the simpler the compensating structure (i.e., the free-form surface) of the compensating lens can be; 3) the closer the curvature, radian, etc., of the windshield is to a flat plate (i.e., the greater the curvature of the windshield itself), the smaller the astigmatism caused is, and the simpler the compensating structure of the compensating lens can be.

The applicant has also summarized quantitative laws of the compensating lens after a lot of experimental research, and for the convenience of presentation, herein, a direction parallel to the optical axis is defined as a Z-axis direction, a direction perpendicular to the Z-axis and lying in a meridian plane is defined as a Y-axis direction, and a direction perpendicular to the Z-axis and lying in a sagittal plane is defined as an X-axis direction. Herein, except for the data related to the field-of-view, data not labelled in the X and Y directions are presented as values in the Y direction, and sectional views not labelled in the X, Y, and Z directions are presented as sectional views in a YZ plane.

A surface type of the free-form surface of the compensating lens 20 may be defined using, but not limited to, the following non-rotationally symmetric aspheric formula:

$$z = \frac{{cr}^{2}}{1 + \sqrt{1 - ( k + 1 ) {c}^{2} {r}^{2}}} + {\sum }_{i = 1}^{N} {A}_{i} {E}_{i} ( x , y )$$

Here, z is the sagittal height of the surface parallel to the z-axis direction, c is the curvature of the free-form surface, k is the quadratic coefficient, r is a radial diameter of the free-form surface, Ai is the coefficient of the i^{th} extended polynomial, Eᵢ (x, y) is the polynomial expression for x and y, and x and y are values in the x-axis and the y-axis directions on three-dimensional data relative to the sagittal height z respectively.

In an exemplary embodiment, when the compensating lens is disposed on the object-side surface of a flat plate structure such as the optical filter and the protective glass, in the YZ plane, the free-form surface of the compensating lens is convex and asymmetrical relative to the optical axis. More particularly, the free-form surface of the compensating lens is asymmetrical and convex, in a half-droplet-like shape, referring to FIG. 1C.

FIG. 1C is a sectional view of a free-form surface of a compensating lens 20 in a YZ plane, the optical axis is the Z-axis, and as shown in FIG. 1C, in the YZ plane, the free-form surface of the compensating lens 20 is asymmetrically convex in a half-droplet-like shape relative to the optical axis Z. Further, in the YZ plane, the free-form surface of the compensating lens 20 includes a first area 201 located above the optical axis Z and a second area 202 located below the optical axis Z. Those skilled in the art should understand that a radius of curvature of the free-form surface can only have an approximated value. Referring to FIG. 1C, a maximum size of the first area 201 of the free-form surface located above the optical axis Z in the Y-axis direction is d1, then the radius of curvature obtained by equidistantly selecting any three points from the optical axis Z to ½d1 to form a circle may be used as an approximate radius of curvature R(+D) of the first area 201 of the free-form surface located above the optical axis Z. Exemplarily, three points (0, 0), (0, y1) and (0, y2) in FIG. 1C are equally spaced in the +Y-axis direction, and the radius of curvature obtained by making a circle through these three points is the approximate radius of curvature R(+D), and R(+D) is the approximate radius of curvature of the free-form surface of the compensating lens within ½ of the effective light-gathering diameter in the +Y-axis direction.

Similarly, a maximum size of the second area 202 of the free-form surface located below the optical axis Z in the Y-axis direction is d2, then, the radius of curvature obtained by equidistantly selecting any three points from the optical axis Z to ½d2 to form a circle may be used as an approximate radius of curvature R(−D) of the second area 202 of the free-form surface located below the optical axis Z. Exemplarily, three points (0, 0), (0, y3) and (0, y4) in FIG. 1C are equally spaced in the −Y-axis direction, and the radius of curvature obtained by making a circle through these three points is the approximate radius of curvature R(−D), and R(−D) is the approximate radius of curvature of the free-form surface of the compensating lens within ½ of the effective light-gathering diameter in the −Y-axis direction.

In an exemplary embodiment, the approximate radius of curvature R(+D) of the first area 201 located above the optical axis Z of the free-form surface of the compensating lens 20 and the approximate radius of curvature R(−D) of the second area 202 located below the optical axis Z of the free-form surface satisfy: R(+D)/R(−D)≥0.1. In an exemplary embodiment, R(+D)/R(−D) may, for example, be equal to values such as 0.5, 0.7, 0.9, 3.0, and 4.0. Preferably, 10≥R(+D)/R(−D)≥0.6. More specifically, R(+D) and R(−D) may further satisfy R(+D)/R(−D)≥1.1. More preferably, R(+D) and R(−D) may further also satisfy 5≥R(+D)/R(−D)≥1.1. By controlling the free-form surface of the compensating lens 20 to have a particular shape, it may realize compensation for the astigmatism generated by the windshield. Satisfying 5≥R(+D)/R(−D)≥1.1, it may further control the shape of the free-form surface of the compensating lens 20, the compensation for the astigmatism generated by the windshield may be better realized, and at the same time ensuring a good imaging quality of the optical system.

In an exemplary embodiment, the approximate radius of curvature R(+D) of the first area located above the optical axis of the free-form surface of the compensating lens is greater than the approximate radius of curvature R(−D) of the second area located below the optical axis of the free-form surface, i.e., R(+D)>R(−D).

FIG. 1D is a diagram of surface sagittal height distribution of a free-form surface of a compensating lens 20. As shown in FIG. 1D, in the YZ plane, the maximum size of the free-form surface in the Y-axis direction is Dy, then the radius of curvature obtained by equidistantly selecting any three points within a range of upper-lower ¼Dy from the optical axis in the Y-axis direction to form a circle is used as an approximate radius of curvature Ry of the free-form surface in the Y-axis direction. Exemplarily, FIG. 1E illustrates a sectional view of a free-form surface of a compensating lens 20 in a YZ plane, and the radius of curvature, obtained by equidistantly selecting any three points within a range of upper-lower ¼Dy from the optical axis in the Y-axis direction to form a circle, is used as the approximate radius of curvature Ry of the free-form surface in the Y-axis direction. Exemplarily, three points (0, 0), (0, y2), and (0, y3) in FIG. 1E are equally spaced in the Y-axis direction, and the radius of curvature obtained by making a circle through these three points may be used as the approximate radius of curvature Ry; alternatively, in FIG. 1E, three points (0, 0), (0, y1) and (0, y4) are equally spaced in the Y-axis direction, and the radius of curvature obtained by making a circle through these three points may be used as the approximate radius of curvature Ry.

Similarly, as shown in FIG. 1F, in an XZ plane, a maximum size of the free-form surface in the X-axis direction is Dx, then the radius of curvature obtained by equidistantly selecting any three points within a range of left-right ¼Dx from the optical axis in the X-axis direction to form a circle is used as an approximate radius of curvature Rx of the free-form surface in the X-axis direction. Exemplarily, FIG. 1F illustrates a sectional view of a free-form surface of a compensating lens 20 in a XZ plane, and the radius of curvature obtained by equidistantly selecting any three points within a range of left-right ¼Dy from the optical axis in the X-axis direction to form a circle is used as the approximate radius of curvature Rx of the free-form surface in the X-axis direction. Exemplarily, three points (0, 0), (x2, 0), and (x3, 0) in FIG. 1F are equally spaced in the X-axis direction, and the radius of curvature obtained by making a circle through these three points may be used as the approximate radius of curvature Rx; alternatively, in FIG. 1F, three points (0, 0), (x1, 0) and (x4, 0) are equally spaced in the X-axis direction, and the radius of curvature obtained by making a circle through these three points may be used as the approximate radius of curvature Rx.

The above taking three points to make a circle is only an example but not limiting. In addition, generally, coordinates of the points may use a three-point coordinate manner (x, y, z), but Z-axis coordinates are omitted from the description of the coordinates of the points above in embodiments of the present disclosure.

It may be understood that in the YZ plane, the free-form surface of the compensating lens in FIG. 1E above is asymmetrically convex, and in the XZ plane, the free-form surface of the compensating lens in FIG. 1F above is also asymmetrically convex, but the foregoing is only an example but not limiting, and those skilled in the art should understand that, for example, when the compensating lens is disposed on a lens having a concave surface, the compensating lens is adhered to the concave surface of the lens, the free-form surface of the compensating lens may have an overall concave shape. In fact, the free-form surface of the compensating lens may be of any shape, and is not limited to a concave shape or a convex shape, the free-form surface itself is an irregular free-form structure, and a surface structure of the free-form surface may be designed as desired.

In an exemplary embodiment, in a XY plane, an approximate radius of curvature Rx of the free-form surface in the X-axis direction and an approximate radius of curvature Ry of the free-form surface in the Y-axis direction satisfy: Rx/Ry≥0.5. More specifically, Rx and Ry may further satisfy: Rx>Ry. Astigmatism compensation may be realized by controlling the free-form surface of the compensating lens 20 to have a particular shape.

In an exemplary embodiment, in the YZ plane, a connecting line of effective radius vertices of the free-form surface of the compensating lens located above and below the optical axis has an angle of inclination of less than or equal to 5° relative to the plane perpendicular to the optical axis (i.e., the XY plane). Controlling the compensating lens at a certain included angle to the optical axis of the optical system, so that the compensating lens is placed at an angle, is conducive to realizing astigmatism compensation, reducing complexity of the free-form surface, and is also conducive to processing the free-form surface.

In an exemplary embodiment, a maximum thickness d of the compensating lens in a direction parallel to the optical axis, and a length TTL in a direction of the optical axis from the first lens of the lens group to the image plane of the optical system, satisfy: d/TTL≤⅓. Controlling the total track length TTL of the optical system within a certain range, while constraining the maximum thickness d of the compensating lens in the direction of the optical axis, is conducive to ensuring miniaturization of the system.

It may be understood that the compensating lens has a light-admitted area and a light non-admitted area, where the light-admitted area is used for adjusting and spreading light and correcting aberrations of the optical system, while the role of the light non-admitted area includes, but is not limited to, assembling the compensating lens with a mechanism member. As shown in FIG. 1D, in the diagram of surface sagittal height distribution of the free-form surface of the compensating lens, the effective light-gathering diameter D of the compensating lens is usually expressed in the form of Dy×Dx,

$$D = \sqrt{{Dx}^{2} + {Dy}^{2}} ,$$

and Dy and Dx represent the effective light-gathering diameters of the free-form surface of the compensating lens in the Y-axis direction and the X-axis direction, respectively. For example, the effective light-gathering diameter D of the free-form surface is 4 mm×7 mm, which represents that the effective light-gathering diameter of the free-form surface in the Y-axis direction is 4 mm, and the effective light-gathering diameter of the free-form surface in the X-axis direction is 7 mm, and it can be obtained from calculation that

$$D = \sqrt{{4}^{2} + {7}^{2}} = 8.06 mm .$$

In an exemplary embodiment, the effective light-gathering diameter D of the free-form surface of the compensating lens and a maximal aperture T of a lens adjacent to the compensating lens in the lens group satisfy: D/T≤6. More specifically, D and T may further satisfy: D/T≤3. When there are two lenses adjacent to the compensating lens, the maximal aperture T of the lens adjacent to the compensating lens is the maximum one in the maximal apertures of the two adjacent lenses. Controlling the effective light-gathering diameter of the compensating lens within a certain range ensures that the entire system has a smaller diameter, which is conducive to miniaturization.

The optical system in embodiments of the present disclosure may effectively improve aberrations caused by the windshield and improve the resolution, by reasonably setting surface parameters, number and position, etc. of the free-form surface of the compensating lens. Exemplarily, in FIG. 1A, the maximal aberration value generated by the windshield of the vehicle (on the image plane of the optical system) is L1, and L1 is the maximal aberration value generated by the windshield on the image plane of the optical system, in the case where the optical system is not provided with the compensating lens. Embodiments of the present disclosure may, by adding the compensating lens to the optical system, reduce the aberration L1 in FIG. 1A to L1′, L1′≤½L1, and the free-form surface of the compensating lens is configured to compensate for the astigmatism generated by the windshield of the vehicle.

In an exemplary embodiment, the optical system in embodiments of the present disclosure may be used in a vehicle-mounted camera, in particular in a front-view ADAS camera of an intelligent vehicle. It should be understood that the optical system in embodiments of the present disclosure may of course also be used in other camera mechanisms or optical mechanisms other than the vehicle-mounted camera.

In an exemplary embodiment, production of the compensating lens may be accomplished through nanoimprinting, mould processing, lamination, etc. The compensating lens is less costly and do not affect aesthetics of the windshield compared to front prisms in conventional solutions.

The optical system provided in embodiments of the present disclosure has a small-volume compensating lens, and the optical system has only one additional compensating lens having a free-form surface, compared to conventional lens assemblies.

The compensating lens of the optical system provided in embodiments of the present disclosure may be separately placed on a stand-alone lens assembly, so that different lens assemblies do not affect each other, and the resolution of a module having a combination of multiple lens assemblies may be improved.

The free-form surface of the compensating lens of the optical system provided in embodiments of the present disclosure may be designed with an upper-lower asymmetric and left-right asymmetric surface to correct the irregular astigmatism in each field-of-view direction.

In addition, placement of the optical system provided in embodiments of the present disclosure is not limited and may be mounted on a center axis of the windshield or on a non-center axis of the windshield.

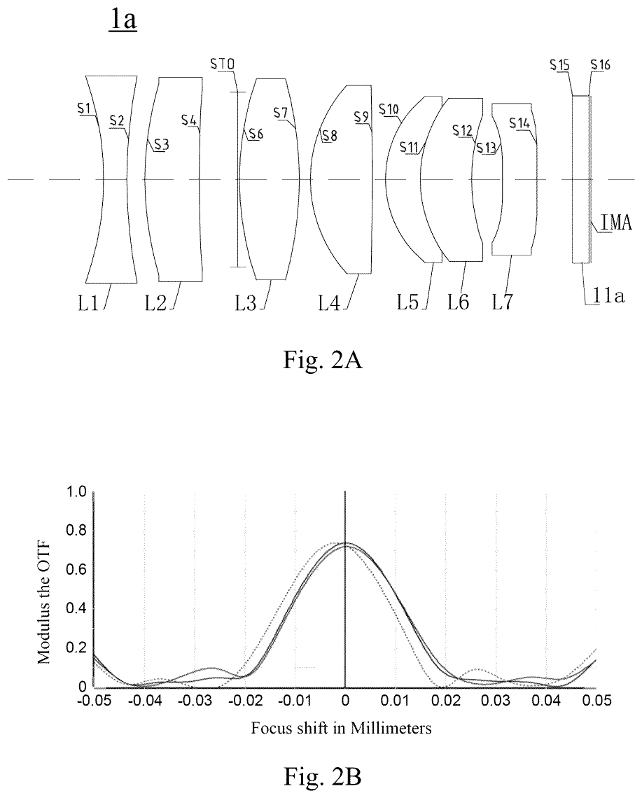

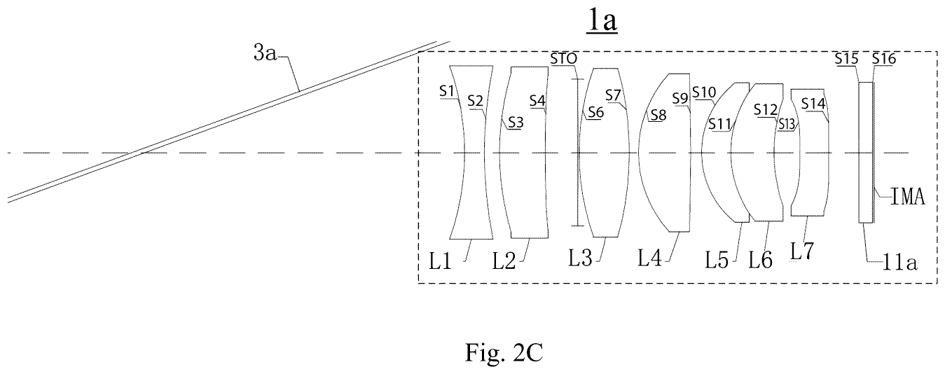

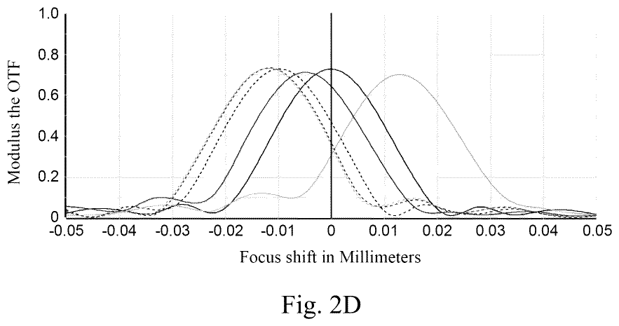

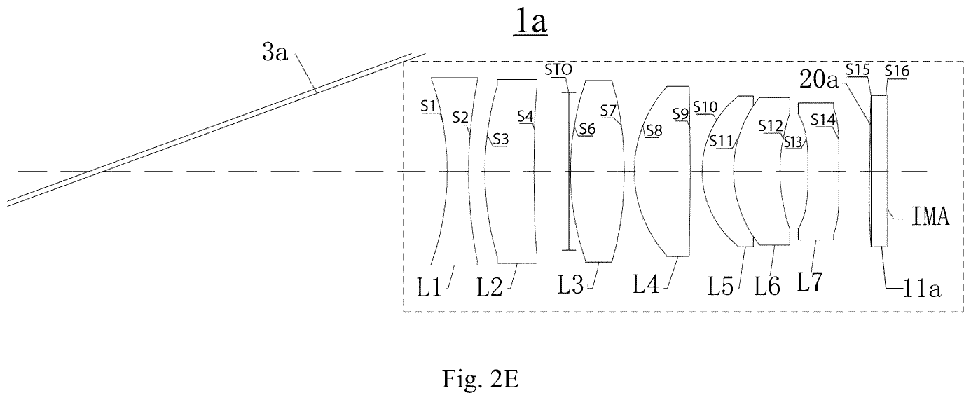

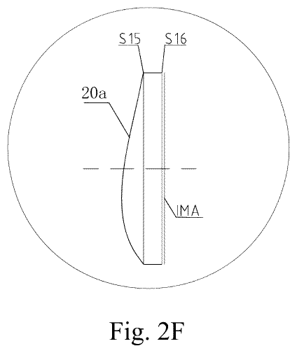

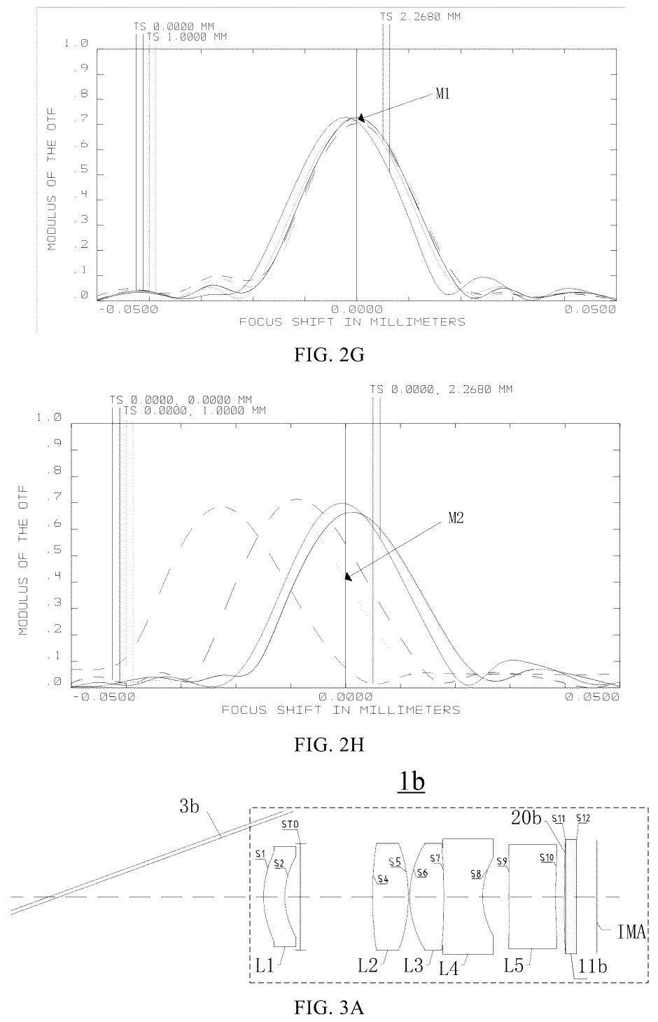

Several detailed embodiments disclosed according to implementations of the present disclosure will be described in detail below in conjunction with FIG. 2A to FIG. 8C, respectively.

### Embodiment 1

FIG. 2A is a schematic structural diagram of an optical system 1a in Embodiment 1 of the present disclosure when a compensating lens is not provided. As shown in FIG. 2A, the optical system 1a may include seven lenses having refractive powers (first lens L1 to seventh lens L7), an optical filter 11a, and an image plane IMA disposed sequentially along an optical axis from an object side to an image side. Light from an object sequentially passes through surfaces (i.e., sequentially passes through an object-side surface S1 of the first lens L1 to an image-side surface S16 of the optical filter 11a) and finally forms an image on the image plane IMA, where, an image sensing chip may be provided at the image plane IMA. The optical system 1a is a seven-piece lens assembly having a total track length TTL of 31 mm, a maximal field-of-view FOV of 30°, a F-number Fno of 1.66, and an effective focal length F of 15.2 mm.

FIG. 2B is a defocus curve graph of the optical system 1a in Embodiment 1 of the present disclosure when a compensating lens is not provided and there is no windshield on an object side thereof. As can be seen from FIG. 2B, when the optical system 1a is not provided with a compensating lens and there is no windshield on the object side thereof, peak positions of defocus curves of the optical system are more centralized, have good focus convergence, and may obtain a good imaging quality in each field-of-view.

FIG. 2C is a schematic diagram of a relative position of the optical system 1a in Embodiment 1 of the present disclosure when a compensating lens is not provided and a windshield 3a. The windshield 3a is disposed on the object side of the optical system 1a.

FIG. 2D is a defocus curve graph of the optical system 1a in Embodiment 1 of the present disclosure when a compensating lens 20a is not provided and there is a windshield 3a on an object side thereof. As can be seen from FIG. 2D, when the optical system 1a is not provided with the compensating lens 20a and there is the windshield 3a on the object side thereof, after passing through the windshield 3a, object-side light may be deflected by the windshield 3a, resulting in that a center optimal image plane and an edge optimal image plane are not on same one plane, thus forming aberrations, that is, a large astigmatism may be generated in imaging. In a light-admitted area of the optical system 1a, in particular, an optical path below the optical axis is deflected by the windshield, thus the optical path below the optical axis is farther away from a center field-of-view than the optical path above the optical axis, and has a greater field curvature astigmatism.

FIG. 2E is a schematic structural diagram of the optical system 1a in Embodiment 1 of the present disclosure when a compensating lens 20a is provided and there is a windshield 3a on an object side thereof, and FIG. 2F is an enlarged view of the compensating lens 20a in FIG. 2E. As shown in FIG. 2E and FIG. 2F, the optical system 1a further includes the compensating lens 20a disposed on an object-side surface of the optical filter 11a, and an object-side surface of the compensating lens 20a is a free-form surface, more specifically, as shown in FIG. 2F, the free-form surface is asymmetrically convex in a half-droplet-like shape. The free-form surface of the compensating lens 20a may improve aberrations generated by light after passing through the windshield 3a.

In the present embodiment, the windshield 3a has an angle of inclination of 70° relative to a plane perpendicular to the optical axis (i.e., a XY plane), and the windshield 3a has a thickness of 5.7 mm. The windshield 3a has a certain curvature in an X-axis direction and a Y-axis direction, therefore, the windshield 3a is a free-form surface glass.

In the present embodiment, the compensating lens 20a is disposed on the object-side surface of the optical filter 11a of the optical system 1a, astigmatism and field curvature corrections are performed by forming a thickness difference between a center thickness and an edge thickness of the free-form surface of the compensating lens 20a, optimal focal point of each field-of-view falls within an effective focal plane to improve resolution. FIG. 2G is a defocus curve graph of the optical system 1a in Embodiment 1 of the present disclosure when a compensating lens 20a is provided and there is a windshield 3a on an object side thereof, i.e., a defocus curve graph of a corrected optical system. As can be seen from FIG. 2G, in Embodiment 1 of the present disclosure, by introducing the compensating lens 20a having a free-form surface on the object-side surface of the optical filter 11a of the optical system 1a to correct aberrations, so that the optical system 1a and the windshield 3a together form the corrected optical system, peak positions of defocus curves of the corrected optical system are more centralized, have good focus convergence, and may obtain a good imaging quality in each field-of-view.

The compensating lens 20a provided in the optical system 1a in Embodiment 1 of the present disclosure is optimally designed when there is a windshield on the object side thereof, and different curves in FIG. 2G represent optical paths at different field-of-views, and in FIG. 2G, an MTF of the corrected optical system formed by the optical system 1a and the windshield 3a together for optical path at each field-of-view is above 70% @119 lp/mm, e.g., in FIG. 2G, the MTF of the corrected optical system for the optical path at certain field-of-view below the optical axis is 74% @119 lp/mm (at M1 in FIG. 2G). However, the optical system 1a in Embodiment 1 provided with the compensating lens 20a has a poor MTF value when there is no windshield on the object side thereof. FIG. 2H illustrates a defocus curve graph of the optical system 1a in Embodiment 1 of the present disclosure when a compensating lens 20a is provided and there is no windshield 3a on an object side thereof, in FIG. 2H, the MTF for the optical path at the field-of-view below the optical axis at the same position as in FIG. 2G above decreases to 40% @119 lp/mm (at M2 in FIG. 2H). That is, the MTF value of the optical system 1a in Embodiment 1 provided with the compensating lens 20a for optical path at at least one field-of-view located in a r portion below the optical axis is improved by 34% when a windshield is provided on the object side of the optical system 1a relative to when there is no windshield on the object side thereof.

Some parameters of the compensating lens 20a are described in detail below.

In the present embodiment, the compensating lens 20a is disposed on the object-side surface of the optical filter 11a, for example, the compensating lens 20a may be adhered to the object-side surface of the optical filter 11a, an image-side surface of the compensating lens 20a is adhered to the object-side surface of the optical filter 11a, and the object-side surface of the compensating lens 20a, serving as a compensating surface, is an upper-lower asymmetric free-form surface. The compensating lens 20a and the optical filter 11a are as a whole placed almost perpendicular to the optical axis, i.e., an angle of inclination of a connecting line, which connects effective radius vertices of the free-form surface of the compensating lens 20a located above and below the optical axis, relative to the plane perpendicular to the optical axis is zero. A maximum thickness d of the compensating lens 20a in a direction of the optical axis is 14 μm, i.e., an effective compensation thickness is 14 μm. The optical filter 11a, which acts to correct colour deviation, has a thickness of 0.55 mm in the direction of the optical axis.

In the present embodiment, an effective light-gathering diameter D of the free-form surface of the compensating lens 20a is represented as 5 mm×9 mm, i.e., representing that the effective light-gathering diameter of the free-form surface in the Y-axis direction is 5 mm, and the effective light-gathering diameter of the free-form surface in the X-axis direction is 9 mm. According to the formula

$$D = \sqrt{{Dx}^{2} + {Dy}^{2}} ,$$

D is calculated to be about 10.3 mm. A maximal aperture T of a lens adjacent to the compensating lens 20a (i.e., the seventh lens L7) is φ10 mm.

In the present embodiment, in a YZ plane, an approximate radius of curvature R(+D) of a first area located above the optical axis of the free-form surface of the compensating lens 20a is 500 mm, and an approximate radius of curvature R(−D) of a second area located below the optical axis of the free-form surface of the compensating lens 20a is 150 mm. R(+D)/R(−D) is 3.33.

In the present embodiment, in a XZ plane, an approximate radius of curvature Rx of the free-form surface of the compensating lens 20a in the X-axis direction is 2500 mm; and in the YZ plane, an approximate radius of curvature Ry of the free-form surface of the compensating lens 20a in the Y-axis direction is 270 mm.

Parameters such as position and surface type of the compensating lens 20a in Embodiment 1 of the present disclosure may be also applicable to an optical system, whose total track length TTL, maximal field-of-view FOV, F-number Fno, and effective focal length F satisfy, respectively: 30 mm≤TTL≤34 mm, 30≤FOV≤36°, 1.6≤Fno≤1.8, and 15 mm≤F≤17 mm. In other words, by adding the compensating lens 20a to the optical system satisfying the above conditions, it is capable of effectively correcting the aberrations introduced by the above windshield 3a and achieving a good imaging quality.

### Embodiment 2

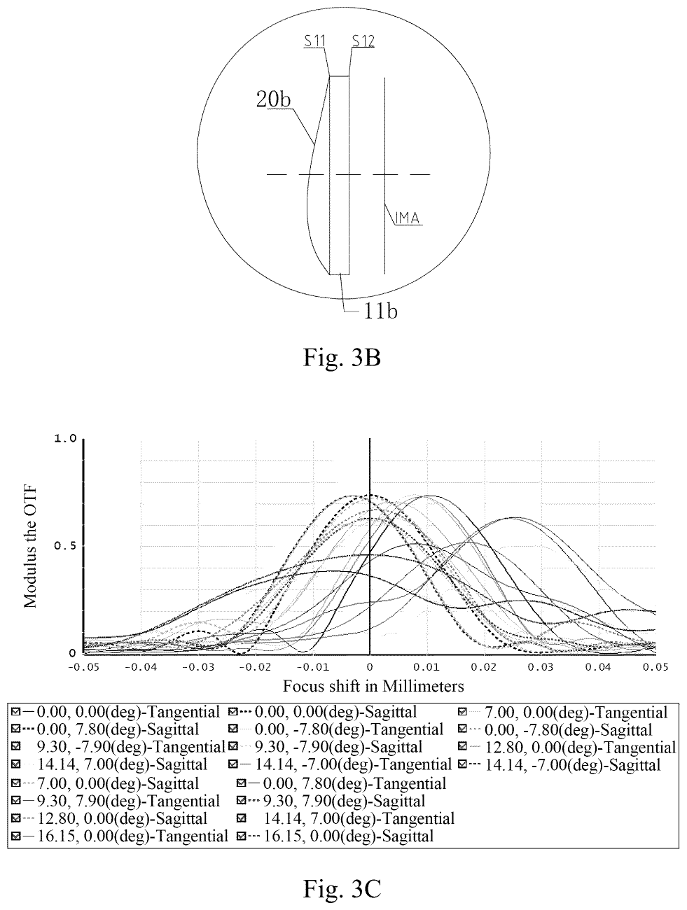

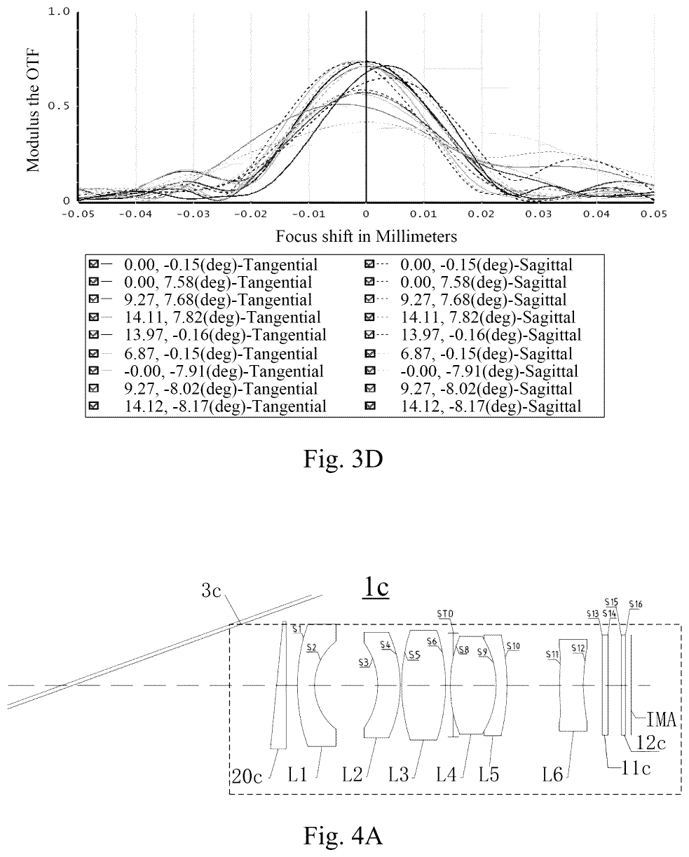

FIG. 3A is a schematic structural diagram of an optical system 1b in Embodiment 2 of the present disclosure. As shown in FIG. 3A, the optical system 1b may include five lenses having refractive powers (first lens L1 to fifth lens L5), a compensating lens 20b, an optical filter 11b, and an image plane IMA disposed sequentially along an optical axis from an object side to an image side. FIG. 3B is an enlarged view of the compensating lens 20b in FIG. 3A.

As shown in FIG. 3A and FIG. 3B, in the present embodiment, the compensating lens 20b is disposed on an object-side surface of the optical filter 11b, and the object-side surface of the compensating lens 20b is a free-form surface, more specifically, the free-form surface is asymmetrically convex in a half-droplet-like shape. The free-form surface of the compensating lens 20b may improve aberrations generated by light after passing through a windshield 3b.

In the present embodiment, the optical system 1b is a five-piece lens assembly having a total track length TTL of 31 mm, a maximal field-of-view FOV of 30°, a F-number Fno of 1.93, and an effective focal length F of 16.6 mm.

In the present embodiment, the windshield 3b is a free-form surface glass, has an angle of inclination of 70° relative to a plane perpendicular to the optical axis (i.e., a XY plane), and has a thickness of 5.7 mm.

Refraction occurs when light passing through the windshield 3b, resulting in increased astigmatism and field curvature in both the meridian direction and the sagittal direction. The compensating lens 20a is disposed on the object-side surface of the optical filter 11b of the optical system 1b in Embodiment 2 of the present disclosure, the object-side surface of the compensating lens 20b is a free-form surface, by forming a thickness difference between a center thickness and an edge thickness of the free-form surface of the compensating lens 20b to perform astigmatism and field curvature correction, optimal focal point of each field-of-view falls within an effective focal plane to improve the resolution.

FIG. 3C is a defocus curve graph of the optical system 1b in Embodiment 2 of the present disclosure when a compensating lens 20b is not provided and there is a windshield 3b on an object side thereof, FIG. 3D is a defocus curve graph of the optical system 1b in Embodiment 2 of the present disclosure when a compensating lens 20b is provided and there is a windshield 3b on an object side thereof, i.e., a defocus curve graph of a corrected optical system. As can be seen from FIG. 3C and FIG. 3D, in Embodiment 2 of the present disclosure, by introducing the compensating lens 20b having a free-form surface between the optical filter 11b and the protective glass 12b of the optical system 1b to correct the aberrations, so that the optical system 1b and the windshield 3b together form the corrected optical system, peak positions of defocus curves of the corrected optical system are more centralized, having good focus convergence, and may obtain a good imaging quality in each field-of-view.

In addition, as seen from FIG. 3D, an MTF of the corrected optical system for the optical path at at least one field-of-view below the optical axis is 50% @120 lp/mm, which is able to reach a preset range.

In the present embodiment, an MTF value of the optical system for the optical path at at least one field-of-view in a portion below the optical axis, can be improved by at least 5% when a windshield is provided on the object side of the optical system, relative to when there is no windshield on the object side thereof.

Some parameters of the compensating lens 20b are described in detail below.

In the present embodiment, the compensating lens 20b is disposed on the object-side surface of the optical filter 11b, for example, the compensating lens 20b may be adhered to the object-side surface of the optical filter 11b, an image-side surface of the compensating lens 20b is adhered to the object-side surface of the optical filter 11b, and the object-side surface of the compensating lens 20b, serving as a compensating surface, is an upper-lower asymmetric free-form surface. The compensating lens 20b and the optical filter 11b are placed almost perpendicular to the optical axis, i.e., an angle of inclination of a connecting line, which connects the effective radius vertices of the free-form surface of the compensating lens 20b located above and below the optical axis, relative to the plane perpendicular to the optical axis is zero. A maximum thickness d of the compensating lens 20b in a direction of the optical axis is 0.55 mm.

In the present embodiment, an effective light-gathering diameter D of the free-form surface of the compensating lens 20b is 5 mm×9 mm, representing that the effective light-gathering diameter of the free-form surface in the Y-axis direction is 5 mm, and the effective light-gathering diameter of the free-form surface in the X-axis direction is 9 mm. A maximal aperture T of a lens adjacent to the compensating lens 20b (i.e., the fifth lens L5) is φ10 mm.

In the present embodiment, in a YZ plane, an approximate radius of curvature R(+D) of a first area located above the optical axis of the free-form surface of the compensating lens 20b is 480 mm, and an approximate radius of curvature R(−D) of a second area located below the optical axis of the free-form surface of the compensating lens 20b is 130 mm. R(+D)/R(−D) is 3.69.

In the present embodiment, in a XZ plane, an approximate radius of curvature Rx of the free-form surface of the compensating lens 20b in the X-axis direction is 2500 mm; and in the YZ plane, an approximate radius of curvature Ry of the free-form surface of the compensating lens 20b in the Y-axis direction is 270 mm.

Parameters such as position and surface type of the compensating lens 20b in Embodiment 2 of the present disclosure may be also applicable to an optical system, whose total track length TTL, maximal field-of-view FOV, F-number Fno, and effective focal length F satisfy, respectively: 30 mm≤TTL≤33 mm, 30≤FOV≤36°, 1.6≤Fno≤2.0, and 15 mm≤F≤17 mm. In other words, by adding the compensating lens 20 to the optical system satisfying the above conditions, it is capable of effectively correcting the aberrations introduced by the above windshield 3b and achieving a good imaging quality.

### Embodiment 3

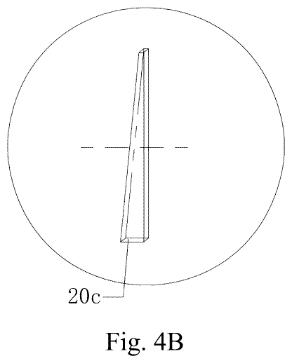

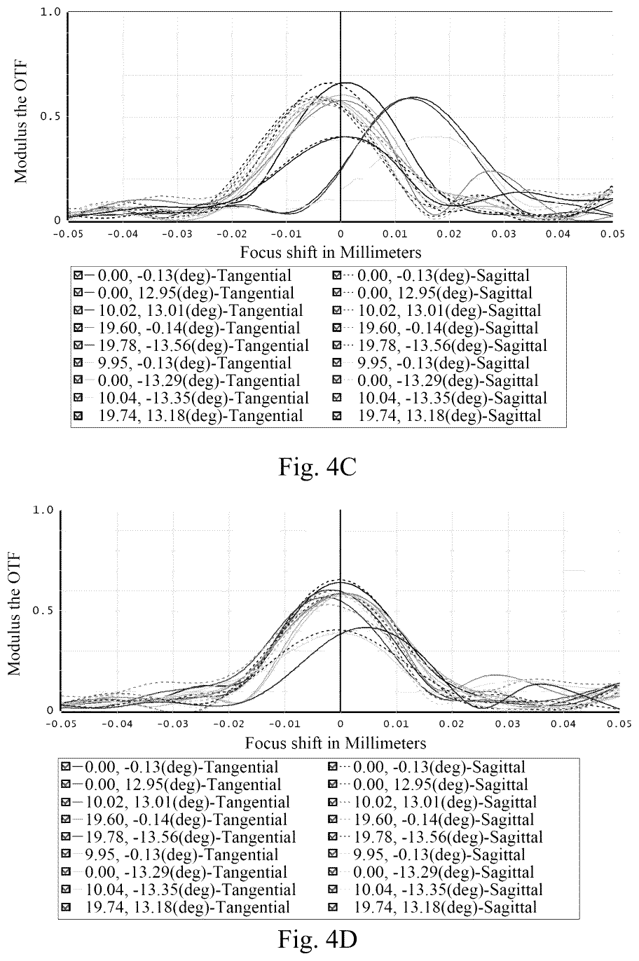

FIG. 4A is a schematic structural diagram of an optical system 1c in Embodiment 3 of the present disclosure. As shown in FIG. 4A, the optical system 1c may include a compensating lens 20c, six lenses having refractive powers (first lens L1 to sixth lens L6), an optical filter 11c, a protective glass 12c and an image plane IMA disposed sequentially along an optical axis from an object side to an image side.

In the present embodiment, the optical system 1c is a six-piece lens assembly having a total track length TTL of 30.3 mm, a maximal field-of-view FOV of 48°, a F-number Fno of 1.61, and an effective focal length F of 8.2 mm.

In the present embodiment, a windshield 3c is a free-form surface glass, has an angle of inclination of 70° relative to a plane perpendicular to the optical axis, and has a thickness of 5.5 mm.

FIG. 4B is an enlarged view of the compensating lens 20c in FIG. 4A. Some parameters of the compensating lens 20c are described in detail below with reference to FIG. 4A and FIG. 4B.

In the present embodiment, the compensating lens 20c is a stand-alone compensating device disposed between the first lens L1 closest to the object side and the windshield 3c, the compensating lens 20c has an overall wedge shape, and an object-side surface of the compensating lens 20c is an inclined free-form surface, more specifically, may be an upper-lower asymmetric free-form surface. A maximum thickness d of the compensating lens 20c in a direction of the optical axis is 0.55 mm. An angle of inclination of a connecting line, which connects the effective radius vertices of the free-form surface of the compensating lens 20c located above and below the optical axis, relative to the plane perpendicular to the optical axis is 2°.

In the present embodiment, an effective light-gathering diameter D of the free-form surface of the compensating lens 20c is 7.5 mm×6 mm, representing that the effective light-gathering diameter of the free-form surface in the Y-axis direction is 7.5 mm, and the effective light-gathering diameter of the free-form surface in the X-axis direction is 6 mm. A maximal aperture T of a lens adjacent to the compensating lens 20c (i.e., the first lens L1) is 5.2 mm.

In the present embodiment, in a YZ plane, an approximate radius of curvature R(+D) of a first area located above the optical axis of the free-form surface of the compensating lens 20c is 10.024 mm, and an approximate radius of curvature R(−D) of a second area located below the optical axis of the free-form surface of the compensating lens 20c is 104 mm. R(+D)>R(−D) and R(+D)/R(−D) is approximated as 1.0.

In the present embodiment, in a XZ plane, an approximate radius of curvature Rx of the free-form surface of the compensating lens 20c in the X-axis direction is 104 mm, and in the YZ plane, an approximate radius of curvature Ry of the free-form surface of the compensating lens 20c in the Y-axis direction is 104 mm.

Refraction occurs when light passing through the windshield 3c, resulting in increased astigmatism and field curvature in both the meridian direction and the sagittal direction. A wedge-shaped compensating lens 20c is disposed between the first lens L1 closest to the object side and the windshield 3c in Embodiment 3 of the present disclosure, the object-side surface of the compensating lens 20c is a free-form surface, the aberrations generated by the light after passing through the windshield 3c is improved by the free-form surface of the compensating lens 20c, optimal focal point of each field-of-view falls within an effective focal plane to improve the resolution and complete correction.

FIG. 4C is a defocus curve graph of the optical system 1c in Embodiment 3 of the present disclosure when a compensating lens 20c is not provided and there is a windshield 3c on an object side thereof, FIG. 4D is a defocus curve graph of the optical system 1c in Embodiment 3 of the present disclosure when a compensating lens 20c is provided and there is a windshield 3c on an object side thereof, i.e., a defocus curve graph of a corrected optical system. As can be seen from FIG. 4C and FIG. 4D, in Embodiment 3 of the present disclosure, by introducing the compensating lens 20c having a free-form surface between the first lens L1 closest to the object side of the optical system 1c and the windshield 3c to correct the aberrations, so that the optical system 1c and the windshield 3c together form the corrected optical system, peak positions of defocus curves of the corrected optical system are more centralized, having good focus convergence, and may obtain a good imaging quality in each field-of-view.

In addition, as seen from FIG. 4D, an MTF of the corrected optical system for the optical path at at least one field-of-view below the optical axis is 50% @120 lp/mm, which is able to reach a preset range.

In the present embodiment, an MTF value of the optical system for the optical path at at least one field-of-view in a portion below the optical axis, can be improved by at least 5% when a windshield is provided on the object side of the optical system, relative to when there is no windshield on the object side thereof.

Parameters such as position and surface type of the compensating lens 20c in Embodiment 3 of the present disclosure may be also applicable to an optical system, whose total track length TTL, maximal field-of-view FOV, F-number Fno, and effective focal length F satisfy, respectively: 30 mm≤TTL≤33 mm, 30≤FOV≤33°, 1.6≤Fno≤2.0, and 7 mm≤F≤10 mm. In other words, by adding the compensating lens 20 to the optical system satisfying the above conditions, it is capable of effectively correcting the aberrations introduced by the above windshield 3c and achieving a good imaging quality after adding the compensating lens 20c.

### Embodiment 4

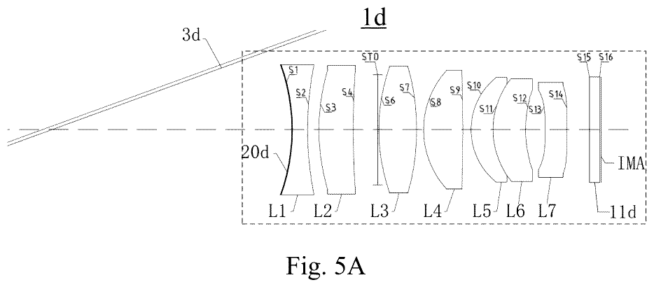

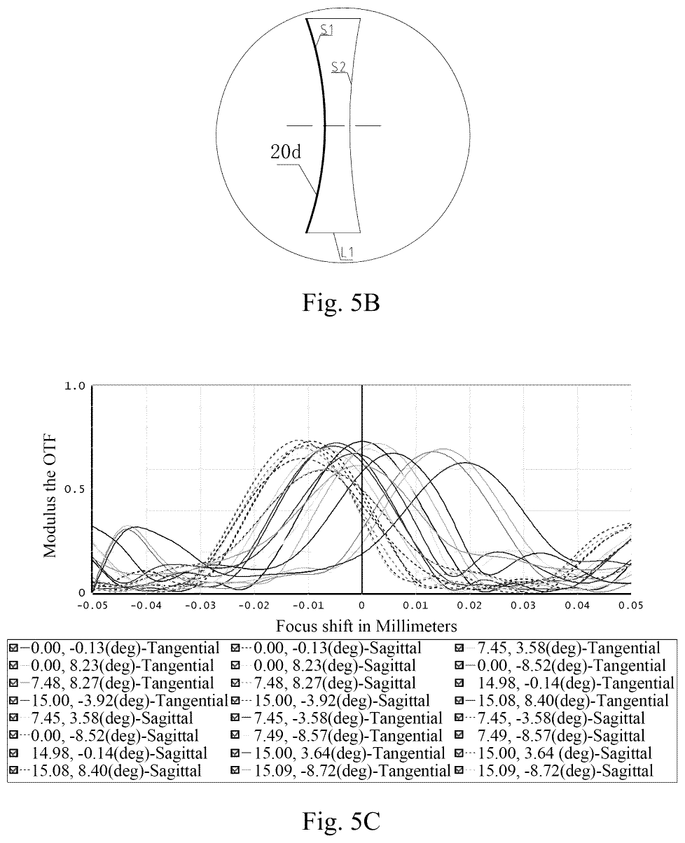

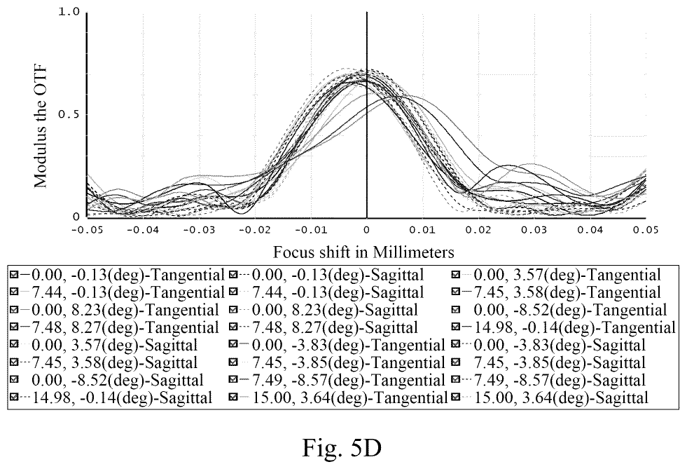

FIG. 5A is a schematic structural diagram of an optical system 1d in Embodiment 4 of the present disclosure. As shown in FIG. 5A, the optical system 1d may include a compensating lens 20d, seven lenses having refractive powers (first lens L1 to seventh lens L7), an optical filter 11d and an image plane IMA disposed sequentially along an optical axis from an object side to an image side.

In the present embodiment, the first lens L1 to the seventh lens L7, the optical filter 11d, a protective glass 12d, and the image plane IMA of the optical system 1d are identical to the first lens L1 to the seventh lens L7, the optical filter 11a, and the image plane IMA in Embodiment 1, and detailed descriptions of a total track length TTL, a maximal field-of-view FOV, a F-number Fno, and an effective focal length F thereof will be omitted.

In the present embodiment, a windshield 3d is a free-form surface glass, has an angle of inclination of 70° relative to a plane perpendicular to the optical axis (i.e., a XY plane), and has a thickness of 6.2 mm. In short, Embodiment 4 differs from Embodiment 1 in that the thickness of the windshield 3d in Embodiment 4 is different from that of the windshield 3a in Embodiment 1, and the position and parameters of the compensating lens 20d in Embodiment 4 are different from those in Embodiment 1.

FIG. 5B is an enlarged view of the compensating lens 20d in FIG. 5A. Some parameters of the compensating lens 20d are described in detail below with reference to FIG. 5A and FIG. 5B.

In the present embodiment, the compensating lens 20d is disposed on an object-side surface of the first lens L1 closest to the object side, for example, the compensating lens 20d may be adhered to the object-side surface of the first lens L1, an image-side surface of the compensating lens 20d is adhered to the object-side surface of the first lens L1, and an object-side surface of the compensating lens 20d, serving as a compensating surface, is an upper-lower asymmetric free-form surface. More specifically, since the object-side surface of the first lens L1 is a concave surface, the compensating lens 20d has an overall asymmetric concave shape. The compensating lens 20d and the first lens L1 may be regarded as one, as a whole placed almost perpendicular to the optical axis, i.e., an angle of inclination of a connecting line, which connects the effective radius vertices of the free-form surface of the compensating lens 20d located above and below the optical axis, relative to the plane perpendicular to the optical axis is zero. A maximum thickness d of the compensating lens 20d and the first lens L1 as a whole in a direction of the optical axis is 1.51 mm.

In the present embodiment, since an effective light-admitted area of the object-side surface of the first lens L1 is circular, an effective light-admitted area of the object-side surface of the compensating lens 20d disposed on the object-side surface of the first lens L1 is also circular, so that an effective light-gathering diameter D of the free-form surface of the compensating lens 20d may be represented as φ 6 mm, representing that a diameter of the effective light-gathering diameter of the free-form surface is 6 mm. In addition, a maximal aperture T of a lens adjacent to the compensating lens 20d (i.e., the first lens L1) is φ7 mm.

In the present embodiment, in a YZ plane, an approximate radius of curvature R(+D) of a first area located above the optical axis of the free-form surface of the compensating lens 20d is 20.2 mm, and an approximate radius of curvature R(−D) of a second area located below the optical axis of the free-form surface of the compensating lens 20d is 20.2 mm. R(+D)/R(−D) is 1.0.

In the present embodiment, in a XZ plane, an approximate radius of curvature Rx of the free-form surface of the compensating lens 20d in the X-axis direction is 20.2 mm; and in the YZ plane, an approximate radius of curvature Ry of the free-form surface of the compensating lens 20d in the Y-axis direction is 20.2 mm.

Refraction occurs when light passing through the windshield 3d, resulting in increased astigmatism and field curvature in both the meridian direction and the sagittal direction. The compensating lens 20d is disposed on the object-side surface of the first lens L1 closest to the object side in Embodiment 4 of the present disclosure, the object-side surface of the compensating lens 20d is a free-form surface, aberrations generated by the light after passing through the windshield 3d is improved by the free-form surface of the compensating lens 20d, optimal focal point of each field-of-view falls within an effective focal plane to improve the resolution and complete correction.

FIG. 5C is a defocus curve graph of the optical system 1d in Embodiment 4 of the present disclosure when a compensating lens 20d is not provided and there is a windshield 3d on an object side thereof, FIG. 5D is a defocus curve graph of the optical system 1d in Embodiment 4 of the present disclosure when a compensating lens 20d is provided and there is a windshield 3d on an object side thereof, i.e., a defocus curve graph of a corrected optical system. As can be seen from FIG. 5C and FIG. 5D, in Embodiment 4 of the present disclosure, by introducing the compensating lens 20d having a free-form surface on the object-side surface of the first lens L1 closest to the object side of the optical system 1d to correct the aberrations, so that the optical system 1d and the windshield 3d together form the corrected optical system, peak positions of defocus curves of the corrected optical system are more centralized, having good focus convergence, and may obtain a good imaging quality in each field-of-view.

In addition, as seen from FIG. 5D, an MTF of the corrected optical system for the optical path at at least one field-of-view below the optical axis is 60% φ119 lp/mm, which is able to reach a preset range.

In the present embodiment, an MTF value of the corrected optical system for the optical path at at least one field-of-view in a portion below the optical axis, can be improved by at least 5% when a windshield is provided on the object side of the optical system, relative to when there is no windshield on the object side thereof.

Parameters such as position and surface type of the compensating lens 20d in Embodiment 4 of the present disclosure may be also applicable to an optical system, whose total track length TTL, maximal field-of-view FOV, F-number Fno, and effective focal length F satisfy, respectively: 30 mm≤TTL≤34 mm, 30≤FOV≤36°, 1.6≤Fno≤1.8, and 15 mm≤F≤17 mm. In other words, by adding the compensating lens 20 to the optical system satisfying the above conditions, it is capable of effectively correcting the aberrations introduced by the above windshield 3d and achieving a good imaging quality.

### Embodiment 5

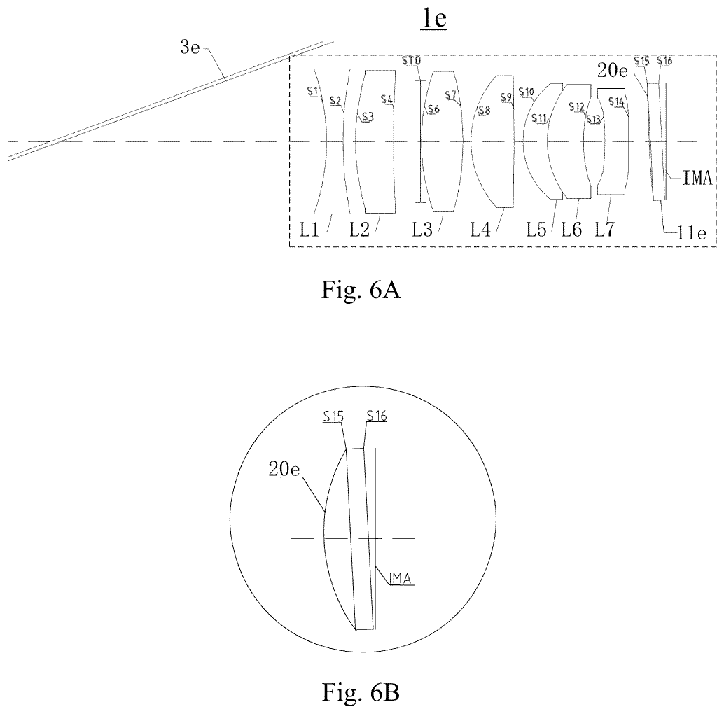

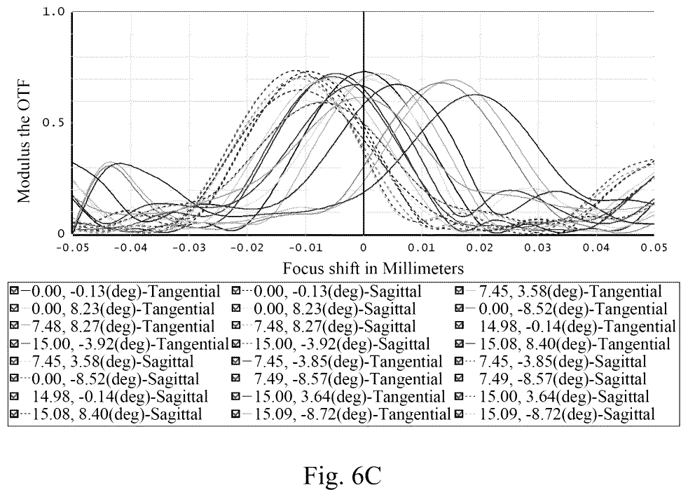

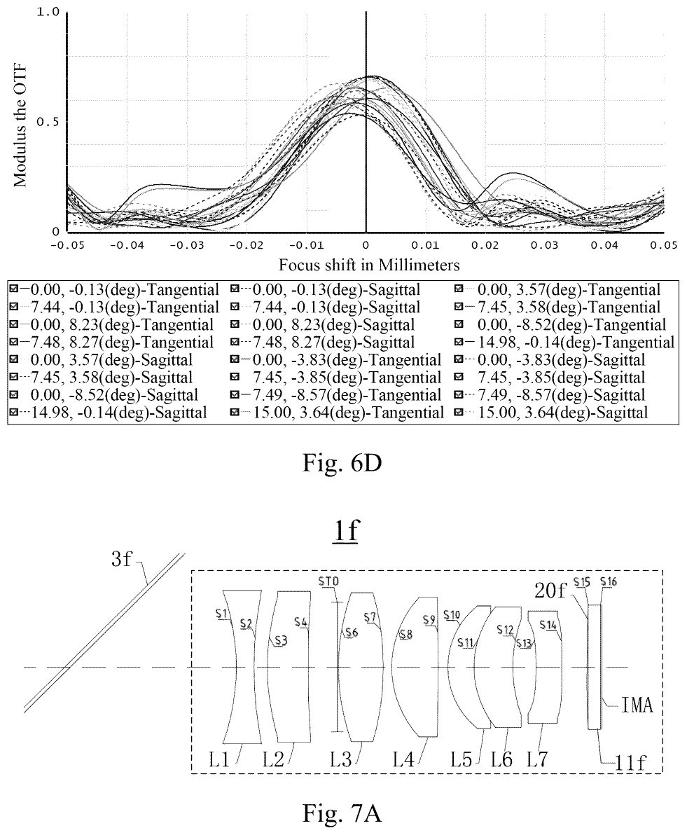

FIG. 6A is a schematic structural diagram of an optical system 1 in Embodiment 5 of the present disclosure. As shown in FIG. 6A, the optical system 1 may include seven lenses having refractive powers (first lens L1 to seventh lens L7), a compensating lens 20e, an optical filter 11e and an image plane IMA disposed sequentially along an optical axis from an object side to an image side.

In the present embodiment, the first lens L1 to the seventh lens L7, the optical filter 11e, and the image plane IMA of the optical system 1 are identical to the first lens L1 to the seventh lens L7, the optical filter 11a, and the image plane IMA in Embodiment 1, and detailed descriptions of a total track length TTL, a maximal field-of-view FOV, a F-number Fno, and an effective focal length F thereof will be omitted.

In the present embodiment, a windshield 3e is identical to the windshield 3d in Embodiment 4, detailed descriptions of an angle of inclination and a thickness thereof will be omitted.

Different from Embodiment 1 and Embodiment 4, the position and parameters of the compensating lens 20e in Embodiment 5 are changed. FIG. 6B is an enlarged view of the compensating lens 20e in FIG. 6A. Some parameters of the compensating lens 20e are described in detail below with reference to FIG. 6A and FIG. 6B.

In the present embodiment, the compensating lens 20e is disposed on an object-side surface of the optical filter 11e, for example, the compensating lens 20e may be adhered to the object-side surface of the optical filter 11e, an image-side surface of the compensating lens 20e is adhered to the object-side surface of the optical filter 11e. The object-side surface of the compensating lens 20e, serving as a compensating surface, is an upper-lower and left-right symmetric double free-form surface, this double free-form surface t is symmetrically convex. More specifically, the compensating lens 20e and the optical filter 11e may be regarded as one, as a whole having an angle of inclination of 3° relative to a plane perpendicular to the optical axis (i.e., a XY plane), i.e., an angle of inclination of a connecting line, which connects the effective radius vertices of the free-form surface of the compensating lens 20e located above and below the optical axis, relative to the plane perpendicular to the optical axis is 3°. A maximum thickness d of the compensating lens 20e and the optical filter 11e as a whole in a direction of the optical axis is 1.51 mm. In addition, the free-form surface of the compensating lens 20e is a double free-form surface, with Rx almost equal to Ry, and its parameters D, R(+D), R(−D), Rx, and Ry are the same as or approximate to those in Embodiment 1, e.g., R(+D) and R(−D) may be fine-tuned on the basis of Embodiment 1 so that R(+D)/R(−D) is about 3.8.

Refraction occurs when light passing through the windshield 3e, resulting in increased astigmatism and field curvature in both the meridian direction and the sagittal direction. The compensating lens 20e is disposed on the object-side surface of the optical filter 11e in Embodiment 5 of the present disclosure, the object-side surface of the compensating lens 20e is a free-form surface, aberrations generated by the light after passing through the windshield 3e is improved by the free-form surface of the compensating lens 20e, optimal focal point of each field-of-view falls within an effective focal plane to improve the resolution and complete correction.

FIG. 6C is a defocus curve graph of the optical system 1 in Embodiment 5 of the present disclosure when a compensating lens 20e is not provided and there is a windshield 3e on an object side thereof, FIG. 6D is a defocus curve graph of the optical system 1 in Embodiment 5 of the present disclosure when a compensating lens 20e is provided and there is a windshield 3e on an object side thereof, i.e., a defocus curve graph of a corrected optical system. As can be seen from FIG. 6C and FIG. 6D, in Embodiment 5 of the present disclosure, by introducing the compensating lens 20e having a free-form surface on the object-side surface of the optical filter 11e of the optical system 1 to correct the aberrations, so that the optical system 1 and the windshield 3e together form the corrected optical system, peak positions of defocus curves of the corrected optical system are more centralized, have good focus convergence, and may obtain a good imaging quality in each field-of-view.

In addition, as seen from FIG. 6D, an MTF of the corrected optical system for optical path at at least one field-of-view below the optical axis is 52% φ119 lp/mm, which is able to reach a preset range.

In the present embodiment, an MTF value of the corrected optical system for optical path at at least one field-of-view in a portion below the optical axis, can be improved by at least 5% when a windshield is provided on the object side of the optical system, relative to when there is no windshield on the object side thereof.

Parameters such as position and surface type of the compensating lens 20e in Embodiment 5 of the present disclosure may be also applicable to an optical system, whose total track length TTL, maximal field-of-view FOV, F-number Fno, and effective focal length F satisfy, respectively: 30 mm≤TTL≤34 mm, 30≤FOV≤36°, 1.6≤Fno≤1.8, and 15 mm≤F≤17 mm. In other words, by adding the compensating lens 20 to the optical system satisfying the above conditions, it is capable of effectively correcting the aberrations introduced by the above windshield 3e and achieving a good imaging quality.

### Embodiment 6

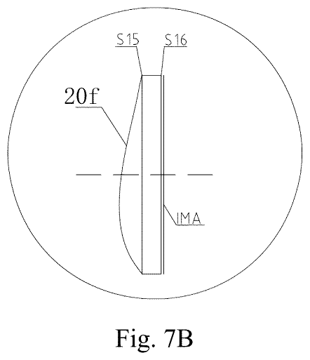

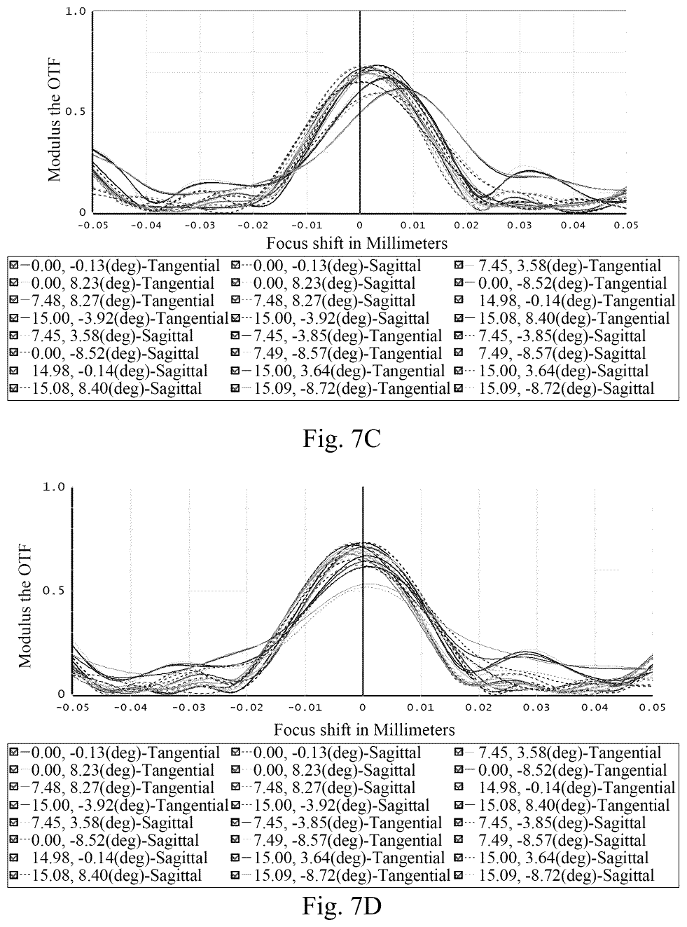

FIG. 7A is a schematic structural diagram of an optical system 1f in Embodiment 6 of the present disclosure. As shown in FIG. 7A, the optical system 1f may include seven lenses having refractive powers (first lens L1 to seventh lens L7), a compensating lens 20f, an optical filter 11f and an image plane IMA disposed sequentially along an optical axis from an object side to an image side.

In the present embodiment, the first lens L1 to the seventh lens L7, the optical filter 11f and the image plane IMA of the optical system 1f are identical to the first lens L1 to the seventh lens L7, the optical filter 11a, and the image plane IMA in Embodiment 1, and detailed descriptions of a total track length TTL, a maximal field-of-view FOV, a F-number Fno, and an effective focal length F thereof will be omitted.

In the present embodiment, a windshield 3f is a free-form surface glass, has an angle of inclination of 45° relative to a plane perpendicular to the optical axis (i.e., a XY plane), and has a thickness of 5.2 mm.

FIG. 7B is an enlarged view of the compensating lens 20f in FIG. 7A. Some parameters of the compensating lens 20f are described in detail below with reference to FIG. 7A and FIG. 7B.

In the present embodiment, the compensating lens 20f is disposed on an object-side surface of the optical filter 11f, for example, the compensating lens 20f may be adhered to the object-side surface of the optical filter 11f, an image-side surface of the compensating lens 20f is adhered to the object-side surface of the optical filter 11f, and an object-side surface of the compensating lens 20f, serving as a compensating surface, is an upper-lower asymmetric free-form surface, this free-form surface is asymmetrically convex in a half-droplet-like shape. More specifically, the compensating lens 20f and the optical filter 11f may be regarded as one, as a whole placed almost perpendicular to the optical axis, i.e., an angle of inclination of a connecting line, which connects the effective radius vertices of the free-form surface of the compensating lens 20f located above and below the optical axis, relative to the plane perpendicular to the optical axis is zero. A maximum thickness d of the compensating lens 20f and the optical filter 11f as a whole in a direction of the optical axis is 0.55 mm.

In the present embodiment, an effective light-gathering diameter D of the free-form surface of the compensating lens 20f is 5 mm×9 mm, representing that the effective light-gathering diameter of the free-form surface in the Y-axis direction is 5 mm, and the effective light-gathering diameter of the free-form surface in the X-axis direction is 9 mm. A maximal aperture T of a lens adjacent to the compensating lens 20f (i.e., the lens having a refractive power and closest to the image side) is φ7 mm.

In addition, parameters R(+D), R(−D), Rx, and Ry of the compensating lens 20f are the same as or approximate to those in Embodiment 1, e.g., R(+D) and R(−D) may be fine-tuned on the basis of Embodiment 1 so that R(+D)/R(−D) is about 4.0, detailed descriptions thereof will be omitted.

Refraction occurs when light passing through the windshield 3f, resulting in increased astigmatism and field curvature in both the meridian direction and the sagittal direction. The compensating lens 20f is disposed on the object-side surface of the optical filter 11f in Embodiment 6 of the present disclosure, the object-side surface of the compensating lens 20f is a free-form surface, aberrations generated by the light after passing through the windshield 3f is improved by the free-form surface of the compensating lens 20f, optimal focal point of each field-of-view falls within an effective focal plane to improve the resolution and complete correction.

FIG. 7C is a defocus curve graph of the optical system 1f in Embodiment 6 of the present disclosure when a compensating lens 20f is not provided and there is a windshield 3f on an object side thereof, FIG. 7D is a defocus curve graph of the optical system 1f in Embodiment 6 of the present disclosure when a compensating lens 20f is provided and there is a windshield 3f on an object side thereof, i.e., a defocus curve graph of a corrected optical system. As can be seen from FIG. 7C and FIG. 7D, in Embodiment 6 of the present disclosure, by introducing the compensating lens 20f having a free-form surface on the object-side surface of the optical filter 11f of the optical system 1f to correct the aberrations, so that the optical system 1f and the windshield 3f together form the corrected optical system, peak positions of defocus curves of the corrected optical system are more centralized, having good focus convergence, and may obtain a good imaging quality in each field-of-view.

In addition, as seen from FIG. 7D, an MTF of the corrected optical system for the optical path at at least one field-of-view below the optical axis is 52% @119 lp/mm, which is able to reach a preset range.

In the present embodiment, an MTF value of the corrected optical system for the optical path at at least one field-of-view in the portion below the optical axis, can be improved by at least 5% when a windshield is provided on the object side of the optical system, relative to when there is no windshield on the object side thereof.

Parameters such as position and surface type of the compensating lens 20f in Embodiment 6 of the present disclosure may be also applicable to an optical system, whose total track length TTL, maximal field-of-view FOV, F-number Fno, and effective focal length F satisfy, respectively: 30 mm≤TTL≤34 mm, 30≤FOV≤36°, 1.6≤Fno≤1.8, and 15 mm≤F≤17 mm. In other words, by adding the compensating lens 20f to the optical system satisfying the above conditions, it is capable of effectively correcting the aberrations introduced by the above windshield 3f and achieving a good imaging quality.

### Embodiment 7

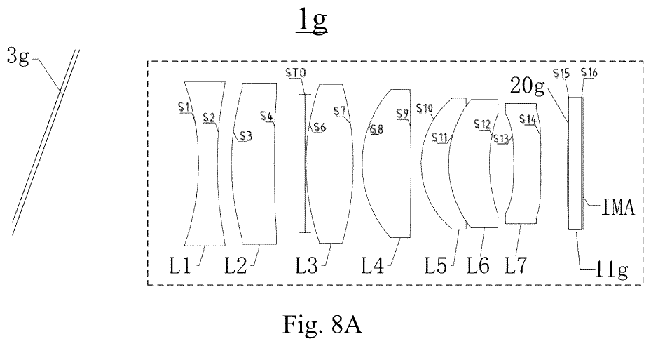

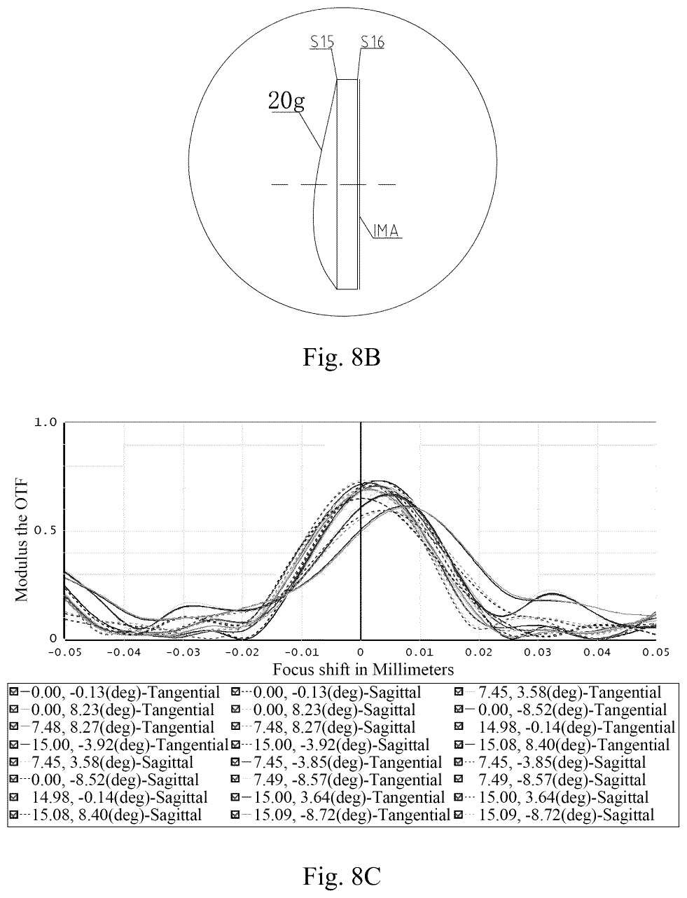

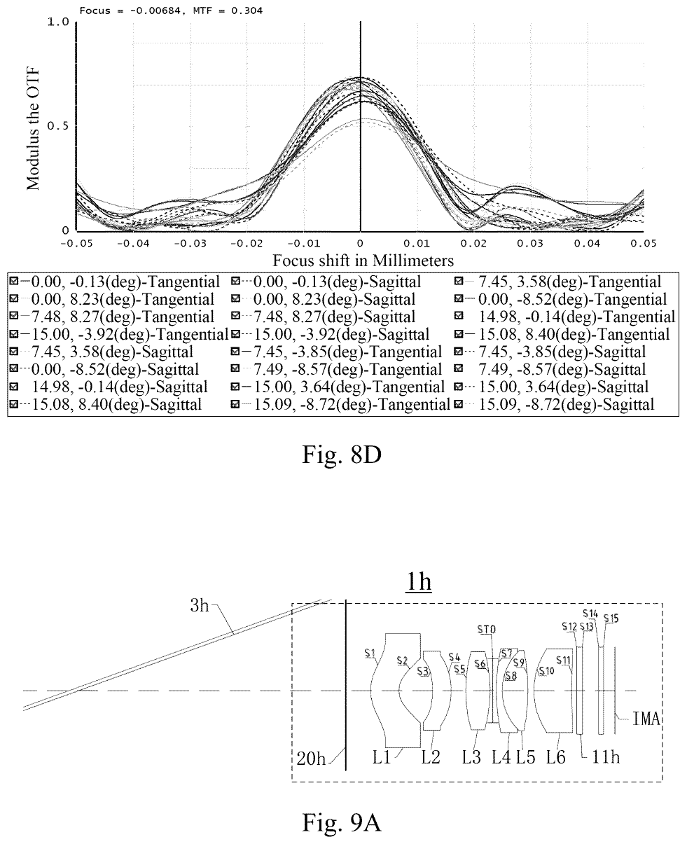

FIG. 8A is a schematic structural diagram of an optical system 1g in Embodiment 7 of the present disclosure. As shown in FIG. 8A, the optical system 1g may include seven lenses having refractive powers (first lens L1 to seventh lens L7), a compensating lens 20g, an optical filter 11g and an image plane IMA disposed sequentially along an optical axis from an object side to an image side.

In the present embodiment, the first lens L1 to the seventh lens L7, the optical filter 11g and the image plane IMA of the optical system 1g are identical to the first lens L1 to the seventh lens L7, the optical filter 11a, and the image plane IMA in Embodiment 1, and detailed descriptions of a total track length TTL, a maximal field-of-view FOV, a F-number Fno, and an effective focal length F thereof will be omitted.

In the present embodiment, a windshield 3g is a free-form surface glass, has an angle of inclination of 20° relative to a plane perpendicular to the optical axis (i.e., a XY plane), and has a thickness of 4.8 mm.

FIG. 8B is an enlarged view of the compensating lens 20g in FIG. 8A. Some parameters of the compensating lens 20g are described in detail below with reference to FIG. 8A and FIG. 8B.

In the present embodiment, the compensating lens 20g is disposed on an object-side surface of the optical filter 11g, for example, the compensating lens 20g may be adhered to the object-side surface of the optical filter 11g, an image-side surface of the compensating lens 20g is adhered to the object-side surface of the optical filter 11g. The object-side surface of the compensating lens 20g, serving as a compensating surface, is an upper-lower asymmetric free-form surface, is asymmetrically convex in a half-droplet-like shape. More specifically, the compensating lens 20g and the optical filter 11g may be regarded as one, as a whole placed almost perpendicular to the optical axis, i.e., an angle of inclination of a connecting line, which connects the effective radius vertices of the free-form surface of the compensating lens 20g located above and below the optical axis, relative to the plane perpendicular to the optical axis is zero. A maximum thickness d of the compensating lens 20g and the optical filter 11g as a whole in a direction of the optical axis is 0.55 mm.

In the present embodiment, an effective light-gathering diameter D of the free-form surface of the compensating lens 20g is 5 mm×9 mm, representing that the effective light-gathering diameter of the free-form surface in the Y-axis direction is 5 mm, and the effective light-gathering diameter of the free-form surface in the X-axis direction is 9 mm. A maximal aperture T of a lens adjacent to the compensating lens 20g (i.e., lens having a refractive power closest to the image side) is φ7 mm.

In addition, parameters R(+D), R(−D), Rx, and Ry of the compensating lens 20g are the same as or approximate to those in Embodiment 1, e.g., R(+D) and R(−D) may be fine-tuned on the basis of Embodiment 1 so that R(+D)/R(−D) is about 2.4, detailed descriptions thereof will be omitted.

Refraction occurs when light passing through the windshield 3g, resulting in increased astigmatism and field curvature in both the meridian direction and the sagittal direction. The compensating lens 20g is disposed on the object-side surface of the optical filter 11g in Embodiment 7 of the present disclosure, the object-side surface of the compensating lens 20g is a free-form surface, aberrations generated by the light after passing through the windshield 3g is improved by the free-form surface of the compensating lens 20g, optimal focal point of each field-of-view falls within an effective focal plane to improve the resolution and complete correction.

FIG. 8C is a defocus curve graph of the optical system 1g in Embodiment 7 of the present disclosure when a compensating lens 20g is not provided and there is a windshield 3g on an object side thereof, FIG. 8D is a defocus curve graph of the optical system 1g in Embodiment 7 of the present disclosure when a compensating lens 20g is provided and there is a windshield 3g on an object side thereof, i.e., a defocus curve graph of a corrected optical system. As can be seen from FIG. 8C and FIG. 8D, in Embodiment 7 of the present disclosure, by introducing the compensating lens 20g having a free-form surface on the object-side surface of the optical filter 11g of the optical system 1g to correct the aberrations, so that the optical system 1g and the windshield 3g together form the corrected optical system, peak positions of defocus curves of the corrected optical system are more centralized, having good focus convergence, and may obtain a good imaging quality in each field-of-view.

In addition, as seen from FIG. 8D, an MTF of the corrected optical system for the optical path at at least one field-of-view below the optical axis of is 52% φ119 lp/mm, which is able to reach a preset range.

In the present embodiment, an MTF value the corrected optical system for the optical path at at least one field-of-view in the portion below the optical axis, can be improved by at least 5% when a windshield is provided on the object side of the optical system, relative to when there is no windshield on the object side thereof.

Parameters such as position and surface type of the compensating lens 20g in Embodiment 7 of the present disclosure may be also applicable to an optical system, whose total track length TTL, maximal field-of-view FOV, F-number Fno, and effective focal length F satisfy, respectively: 30 mm≤TTL≤34 mm, 30≤FOV≤36°, 1.6≤Fno≤1.8, and 15 mm≤F≤17 mm. In other words, by adding the compensating lens 20g to the optical system satisfying the above conditions, it is capable of effectively correcting the aberrations introduced by the above windshield 3g and achieving a good imaging quality.

### Embodiment 8

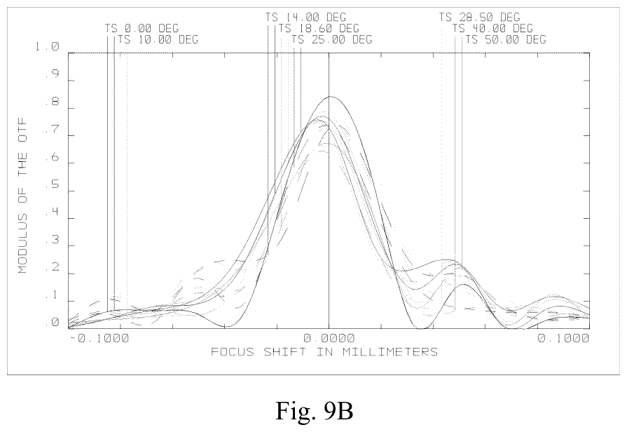

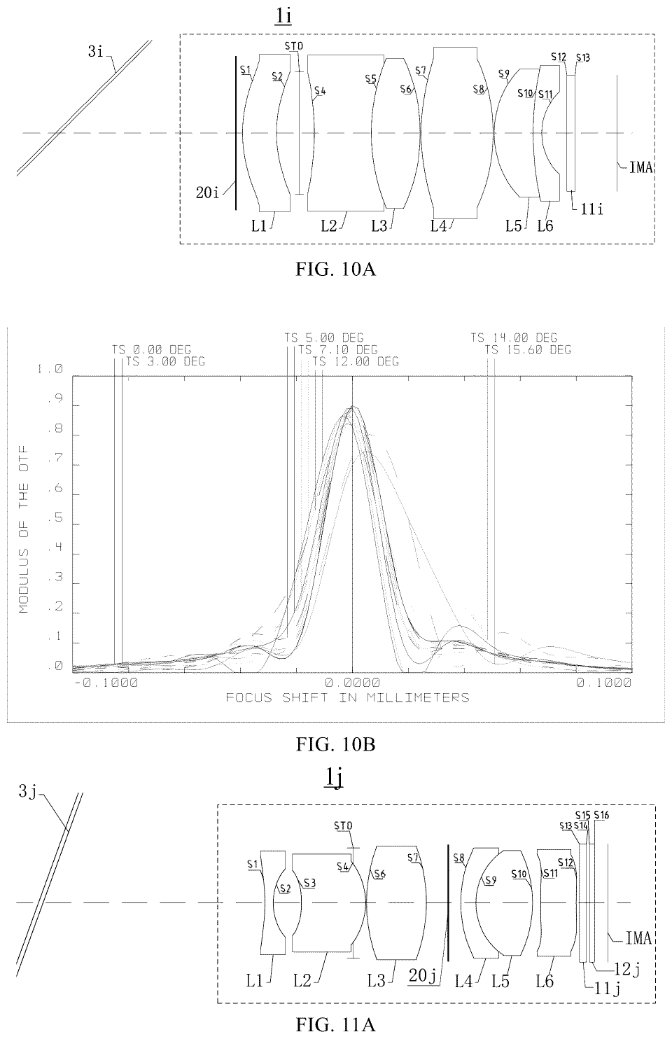

FIG. 9A, FIG. 10A and FIG. 11A are schematic structural diagrams of three optical systems 1h, 1i and 1j in Embodiment 8 of the present disclosure, respectively. The optical systems 1h, 1i and 1j all include six lenses having refractive powers, namely: a first lens L1 to a sixth lens L6.

As shown in FIG. 9A, the compensating lens 20h of the optical system 1h, as a stand-alone compensating device, is disposed between the first lens L1 of the optical system 1h and a windshield 3h.

As shown in FIG. 10A, the compensating lens 20i of the optical system 1i, as a stand-alone compensating device, is disposed between the first lens L1 of the optical system 1i and a windshield 3i.

As shown in FIG. 11A, the compensating lens 20j of the optical system 1j, as a stand-alone compensating device, is disposed between the third lens L3 of the optical system 1j and the fourth lens L4.

FIG. 9B, FIG. 10B and FIG. 11B are defocus curve graphs of the three optical systems 1h, 1i and 1j in Embodiment 8 of the present disclosure when a compensating lens is provided and there is a windshield on an object side thereof, respectively, i.e., defocus curve graphs of three corrected optical systems formed by the three optical systems 1h, 1i and 1j and the windshields 3h, 3i and 3j, respectively. Peak positions of defocus curves of the three corrected optical systems in Embodiment 8 are more centralized, have good focus convergence, and MTFs are all above 50% @65 lp/mm. The unit of MTF in FIG. 9B, FIG. 10B, and FIG. 11B are all @65 lp/mm.

In other embodiments, the compensating lens, as a stand-alone compensating device, may be disposed on either the object side or the image side of any one of the lenses as desired, for example, the compensating lens may be disposed on the image side of a protective glass, more specifically, may be disposed between the protective glass and a photosensitive chip on the image plane.

### Embodiment 9

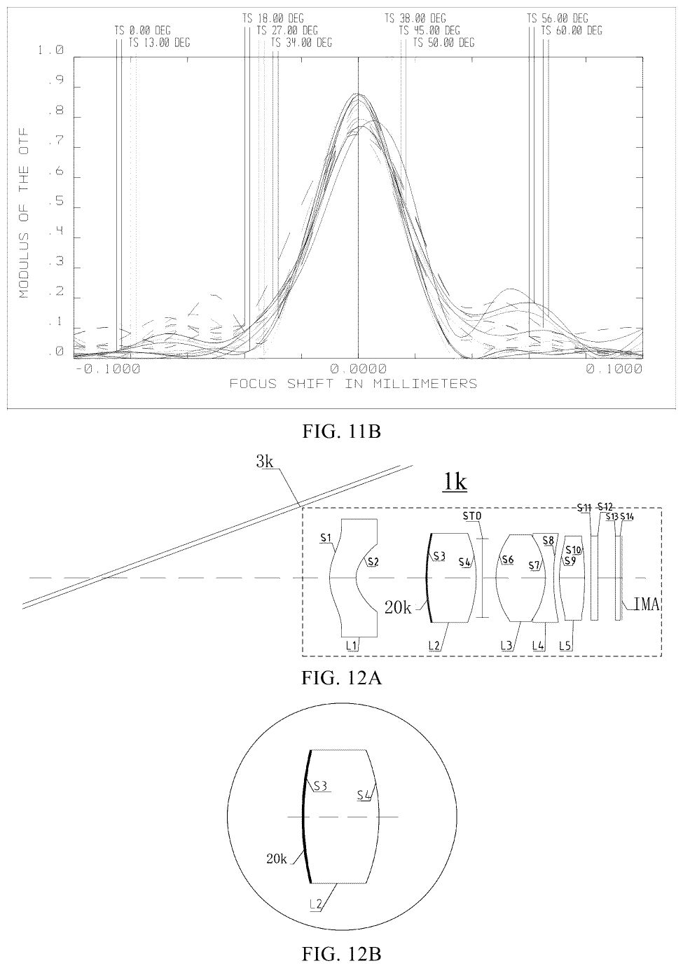

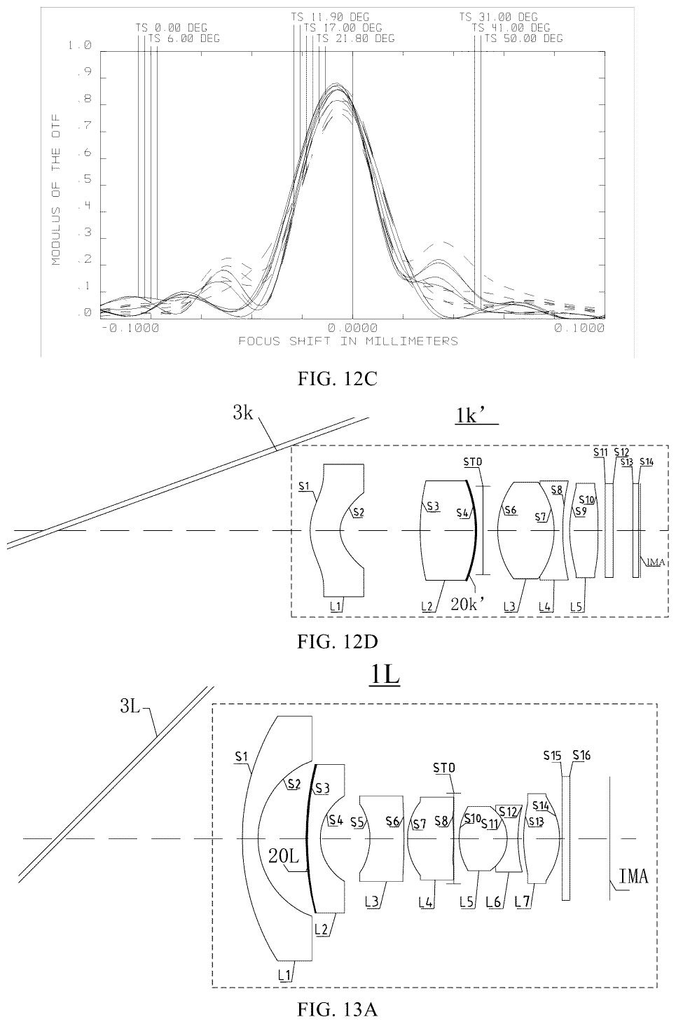

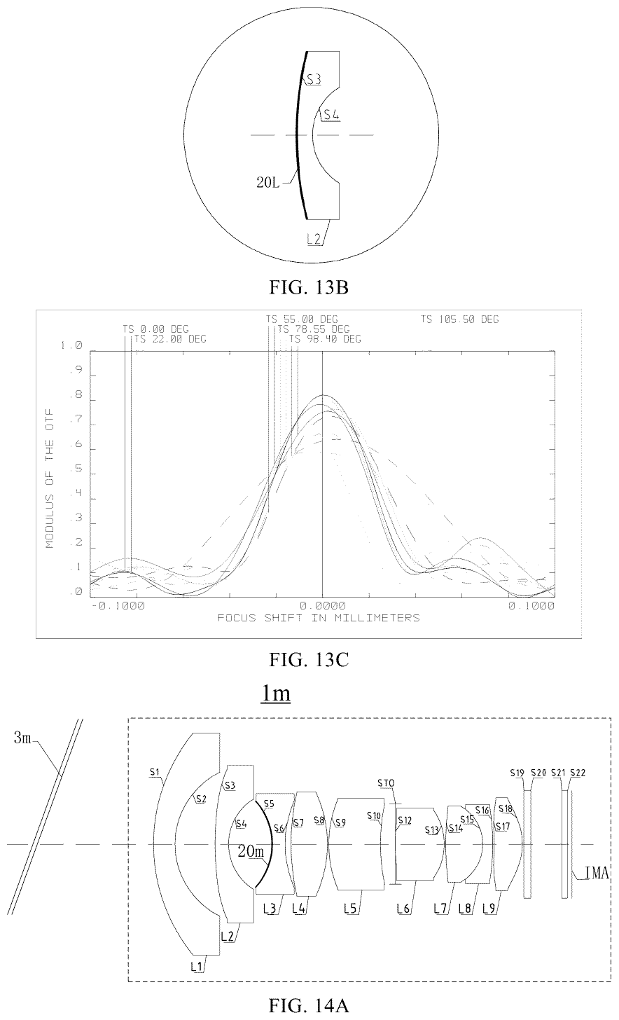

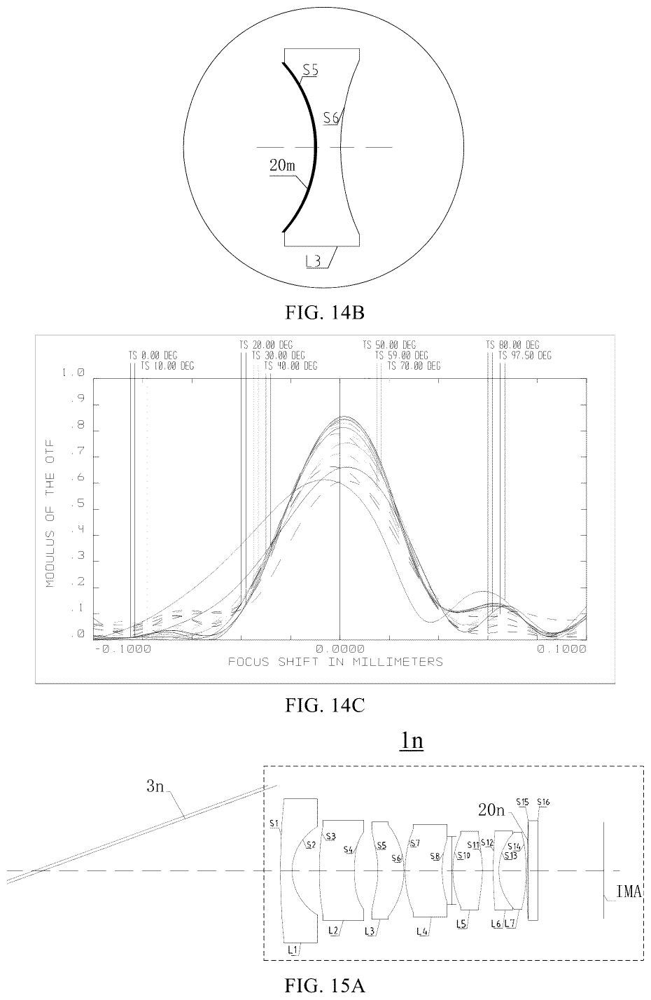

FIG. 12A, FIG. 13A and FIG. 14A are schematic structural diagrams of three optical systems 1k, 1L, 1m in Embodiment 9 of the present disclosure, respectively. FIG. 12B, FIG. 13B and FIG. 14B are enlarged views of compensating lenses of the three optical systems 1k, 1L, 1m in Embodiment 9, respectively.

As shown in FIG. 12A and FIG. 12B, the compensating lens 20k of the optical system 1k is disposed on an object-side surface of a second lens L2. The object-side surface of the second lens L2 is a convex surface, and the compensating lens 20k is adhered to the object-side surface of the second lens L2, therefore, the compensating lens 20k has an overall convex shape.

As shown in FIG. 13A and FIG. 13B, the compensating lens 20L of the optical system 1L is disposed on an object-side surface of a second lens L2. The object-side surface of the second lens L2 is a convex surface, and the compensating lens 20L is adhered to the object-side surface of the second lens L2, therefore, the compensating lens 20L has an overall convex shape.

As shown in FIG. 14A and FIG. 14B, the compensating lens 20m of the optical system 1m is disposed on an object-side surface of a third lens L3. The object-side surface of the third lens L3 is a concave surface, and the compensating lens 20m is adhered to the object-side surface of the third lens L3, therefore, the compensating lens 20m has an overall concave shape.

Object-side surfaces of the compensating lens 20k, the compensating lens 20L, and the compensating lens 20m are free-form surfaces, parameters and shapes of the free-form surfaces may be designed according to the needs, detailed descriptions thereof will be omitted.

FIG. 12C, FIG. 13C and FIG. 14C are defocus curve graphs of the three optical systems 1k, 1L and 1m in Embodiment 9 of the present disclosure when a compensating lens is provided and there is a windshield on an object side thereof, respectively, i.e., defocus curve graphs of three corrected optical systems formed by the three optical systems 1k, 1L and 1m and the windshields 3k, 3L and 3m, respectively. Peak positions of defocus curves of the three corrected optical systems in Embodiment 9 are more centralized, having good focus convergence, and MTFs are all above 50% @65 lp/mm. The unit of MTF in FIG. 12C, FIG. 13C, and FIG. 14C are all @65 lp/mm.

In other embodiments, the compensating lens may be disposed on an object-side surface or an image-side surface of any one of the lenses as desired. The above compensating lens 20k, compensating lens 20L, and compensating lens 20m being disposed on the object-side surfaces of the lenses are only examples but not limiting, and the compensating lenses may also be disposed on the image-side surfaces of the lenses, for example, FIG. 12D is a schematic structural diagram of another optical system 1k′ in Embodiment 9, and a compensating lens 20k′ in FIG. 12D is disposed on the image-side surface of the second lens L2.

### Embodiment 10

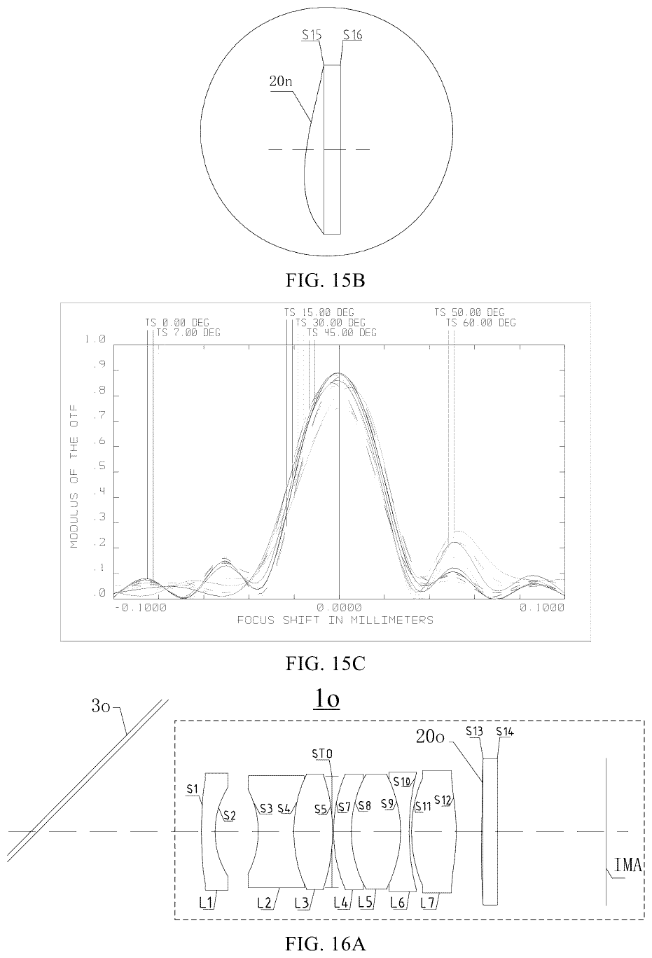

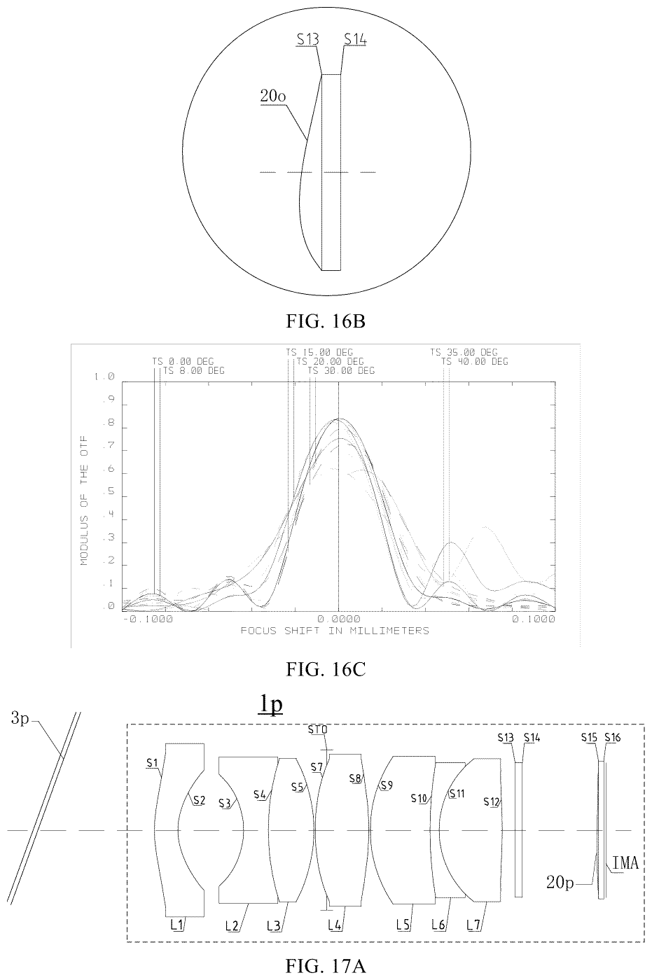

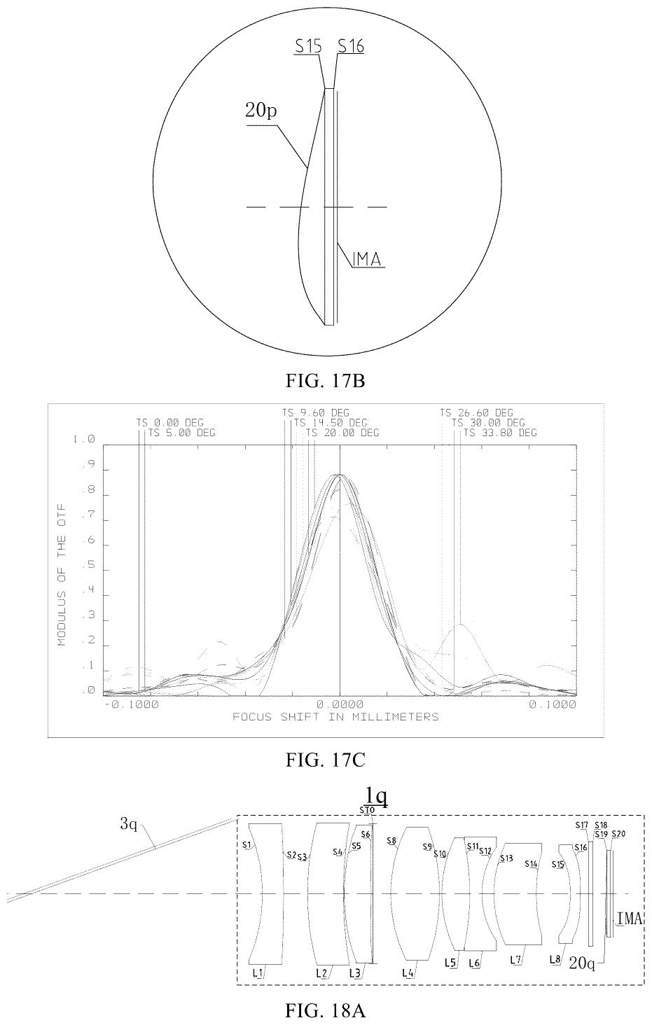

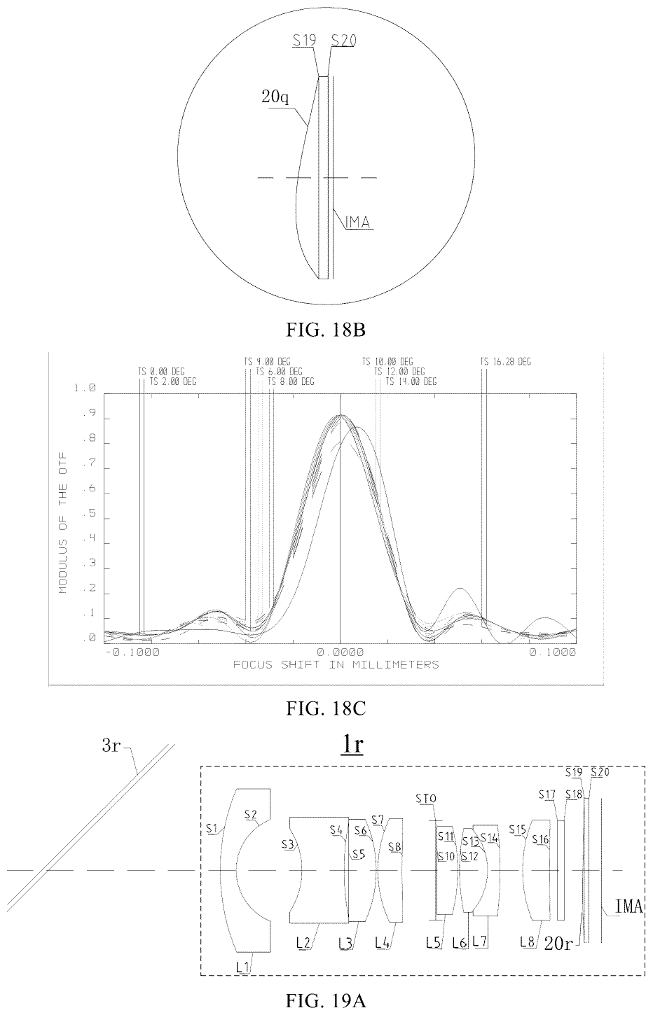

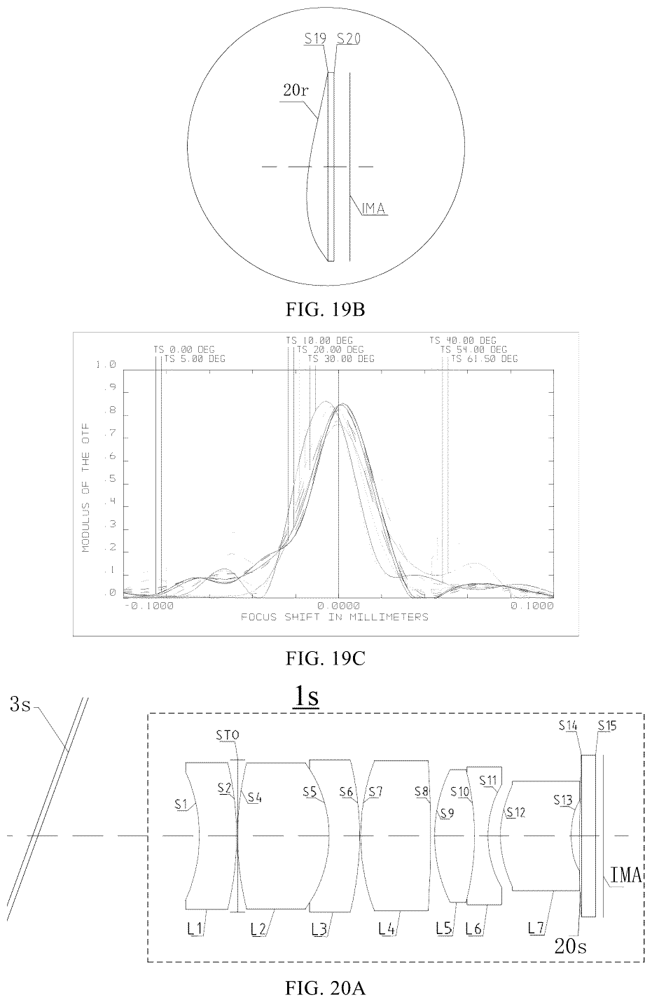

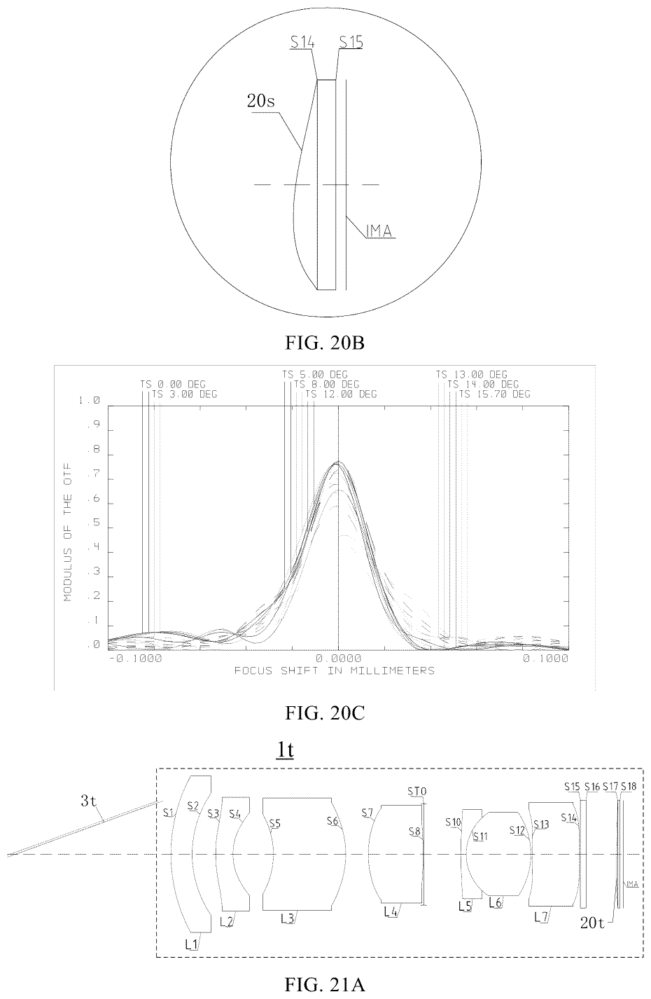

Schematic structural diagrams of seven optical systems according to embodiment 10 of the present disclosure are described below with reference to FIG. 15A to FIG. 21B.

FIG. 15A, FIG. 16A, FIG. 17A, FIG. 18A, FIG. 19A, FIG. 20A, and FIG. 21A are schematic structural diagrams of the seven optical systems 1n, 1o, 1p, 1q, 1r, 1s, and 1t in Embodiment 10 of the present disclosure respectively, and FIG. 15B, FIG. 16B, FIG. 17B, FIG. 18B, FIG. 19B, FIG. 20B, and FIG. 21B are enlarged view of compensating lenses of the seven optical systems 1n, 1o, 1p, 1q, 1r, 1s, and 1t in Embodiment 10, respectively. Each of the compensating lenses of the seven optical systems in the present embodiment is disposed on an object-side surface of an optical filter or an object-side surface of a protective glass, and is overall asymmetrically convex in a half-droplet-like shape. An object-side surface of the compensating lens is a free-form surface, parameters and shape of the free-form surface may be designed according to the needs, detailed descriptions thereof will be omitted.

FIG. 15C, FIG. 16C, FIG. 17C, FIG. 18C, FIG. 19C, FIG. 20C, and FIG. 21C are defocus curve graphs of the seven optical systems 1n, 1o, 1p, 1q, 1r, 1s, and 1t in Embodiment 10 of the present disclosure, respectively, when a compensating lens is provided and there is a windshield on an object side thereof, i.e., defocus curve graphs of seven corrected optical systems formed by seven optical systems 1n, 1o, 1p, 1q, 1r, 1s, 1t and the windshields 3n, 30, 3p, 3q, 3r, 3s, 3t, respectively. Peak positions of defocus curves of the seven corrected optical systems in Embodiment 10 are more centralized, having good focus convergence, and MTFs are all above 50% @65 lp/mm. The unit of MTF in FIG. 15C, FIG. 16C, FIG. 17C, FIG. 18C, FIG. 19C, FIG. 20C, and FIG. 21C are all @65 lp/mm.

### Embodiment 11

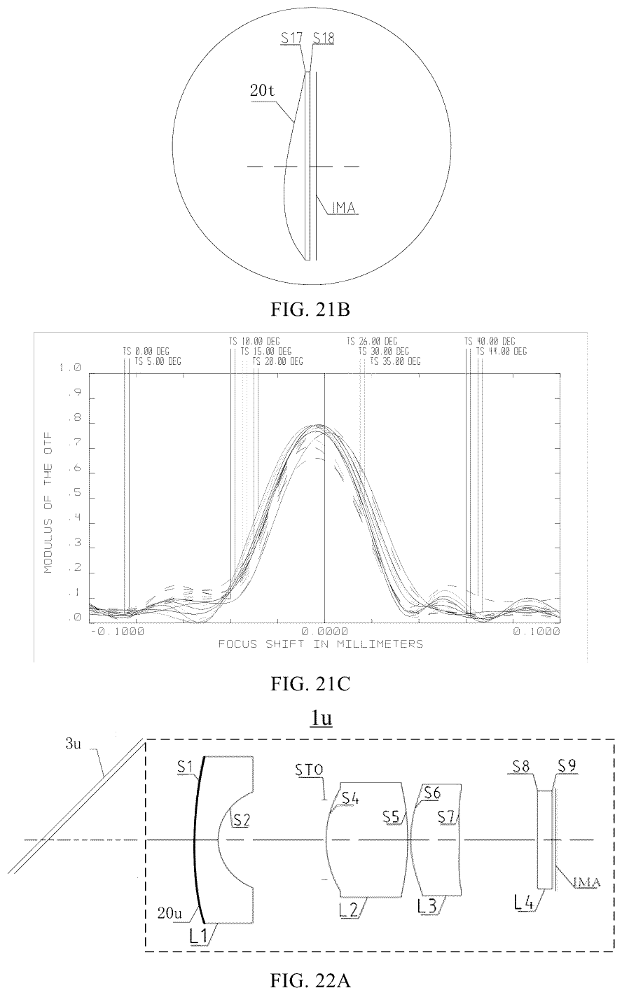

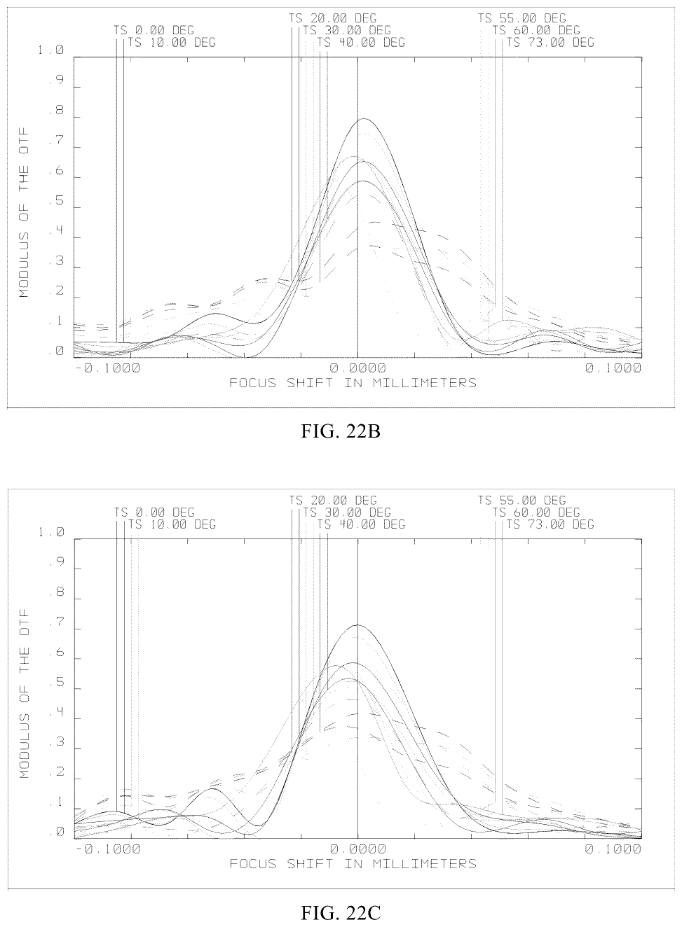

A schematic structural diagram of an optical system 1u according to embodiment 11 of the present disclosure is described below with reference to FIG. 22A to FIG. 22C.

As shown in FIG. 22A, the optical system 1u may include a compensating lens 20u, three lenses having refractive powers (first lens L1 to third lens L3), an optical filter L4 and an image plane IMA disposed sequentially along an optical axis from an object side to an image side.

In the present embodiment, the optical system 1u has a total track length TTL of 12.5 mm, a maximal field-of-view FOV of 145°, a F-number Fno of 1.4, and an effective focal length F of 1.8 mm.

In the present embodiment, a windshield 3u is a free-form surface glass, has an angle of inclination of 45° relative to a plane perpendicular to the optical axis (i.e., a XY plane), and has a thickness of 5.2 mm.

In the present embodiment, the compensating lens 20u is disposed on an object-side surface of the first lens L1 closest to the object side, for example, the compensating lens 20u may be adhered to the object-side surface of the first lens L1, an image-side surface of the compensating lens 20u is adhered to the object-side surface of the first lens L1. The object-side surface of the compensating lens 20u, serving as a compensating surface, is an upper-lower asymmetric free-form surface. More specifically, since the object-side surface of the first lens L1 is a convex surface, the compensating lens 20u has an overall asymmetric convex shape. The compensating lens 20u and the first lens L1 may be regarded as one, as a whole placed almost perpendicular to the optical axis, i.e., an angle of inclination of a connecting line, which connects effective radius vertices of the free-form surface of the compensating lens 20u located above and below the optical axis relative to the plane perpendicular to the optical axis is zero. A maximum thickness d of the compensating lens 20u and the first lens L1 as a whole in a direction of the optical axis is 0.85 mm.

In the present embodiment, since an effective light-admitted area of the object-side surface of the first lens L1 is circular, an effective light-admitted area of the object-side surface of the compensating lens 20u disposed on the object-side surface of the first lens L1 is also circular, so that an effective light-gathering diameter D of the free-form surface of the compensating lens 20u may be represented as φ6 mm, representing that a diameter of the effective light-gathering diameter of the free-form surface is 6 mm. In addition, a maximal aperture T of a lens adjacent to the compensating lens 20u (i.e., the first lens L1) is φ6.5 mm.

In the present embodiment, in a YZ plane, an approximate radius of curvature R(+D) of a first area located above the optical axis of the free-form surface of the compensating lens 20u is 16.78 mm, and an approximate radius of curvature R(−D) of a second area located below the optical axis of the free-form surface of the compensating lens 20u is 16.78 mm. R(+D)/R(−D) is 1.0.

In the present embodiment, in a XZ plane, an approximate radius of curvature Rx of the free-form surface of the compensating lens 20u in the X-axis direction is 16.78 mm; and in the YZ plane, an approximate radius of curvature Ry of the free-form surface of the compensating lens 20u in the Y-axis direction is 16.78 mm.

FIG. 22B is a defocus curve graph of the optical system 1u in Embodiment 11 of the present disclosure when a compensating lens 20u is provided and there is a windshield 3u on an object side thereof, i.e., a defocus curve graph of a corrected optical system. As seen from FIG. 22B, an MTF of the corrected optical system formed by the optical system 1u and the windshield 3u together for the optical path at at least one field-of-view below the optical axis is 54% @60 lp/mm, which is able to reach a preset range. In Embodiment 11 of the present disclosure, by introducing the compensating lens 20u having a free-form surface on the object-side surface of the first lens L1 closest to the object side of the optical system 1u to correct aberrations, so that the optical system 1u and the windshield 3u together form the corrected optical system, peak positions of defocus curves of the corrected optical system are more centralized, having good focus convergence, and may obtain a good imaging quality in each field-of-view.

The compensating lens 20u provided in the optical system 1u in Embodiment 11 of the present disclosure is optimally designed when there is a windshield on the object side thereof, however, the optical system 1u provided with the compensating lens 20u in Embodiment 11 has a poor MTF value when there is no windshield on the object side thereof. FIG. 22C is a defocus curve graph of the optical system in Embodiment 11 of the present disclosure when a compensating lens is provided and there is no windshield on an object side thereof. As can be seen from a comparison of FIG. 22B and FIG. 22C, the MTF value of the optical system 1u provided with the compensating lens 20u in Embodiment 11, for the optical path at at least one field-of-view in a portion below the optical axis, is improved by at least 5%, when a windshield is provided on the object side of the optical system 1u relative to when there is no windshield on the object side thereof.

Parameters such as position and surface type of the compensating lens 20u in Embodiment 11 of the present disclosure may be also applicable to an optical system, whose total track length TTL, maximal field-of-view FOV, F-number Fno, and effective focal length F satisfy, respectively: 12 mm≤TTL≤15 mm, 120°≤FOV≤140°, 1.4≤Fno≤1.6, and 1.5 mm≤F≤2 mm. In other words, by adding the compensating lens 20u to the optical system satisfying the above conditions, it is capable of effectively correcting the aberrations introduced by the above windshield 3u and achieving a good imaging quality.

It should be understood by those skilled in the art that the above description is only preferred embodiments of the present disclosure and an illustration of the technical principles utilized. Embodiments of the present disclosure do not limit the curvature, thickness, degree of inclination, etc. of the windshield, for example, the thickness of the windshield may be in the range of 3 mm to 10 mm, but is not limited thereto. Embodiments of the present disclosure do not limit the number and material of the lenses in the optical system, and does not limit the total track length TTL, the maximal field-of-view FOV, the F-number Fno, the effective focal length F, etc. of the optical system. For example, the number of lenses may be 3, 4, 5, 6, 7, 8, etc., but is not limited thereto, and the FOV may be about 30°, about 45°, about 60°, etc., but is not limited thereto. Schemes of the present disclosure are applicable to various types of windshields and lens assemblies, and without departing from the technical solution of the present disclosure, the number of compensating lenses, the parameters such as position and surface type, may be varied to obtain the various results and advantages described in embodiments of the present disclosure. For example, although a single compensating lens is described as an example in the embodiments, the optical system in the technical solution of the present disclosure is not limited to including a single compensating lens. The optical system may also include other numbers of compensating lenses, if desired.

In another aspect, the present disclosure provides a vehicle-mounted camera, the vehicle-mounted camera including: the above optical system, and a photosensitive component circuit and a control component for converting an optical image formed by the optical system into an electrical signal. Exemplarily, the vehicle-mounted camera may be an image sensor integrated in, e.g., an advanced driver assistance system (ADAS), for image and video collection of the advanced driver assistance system. The vehicle-mounted camera, as a main vision sensor of the ADAS system, collects images by means of the optical system described above, and then the photosensitive component circuit and the control component within the camera process the images and convert them into digital signals that can be processed by a computer, so as to realize ADAS functions such as forward collision warning, lane departure alarm, and pedestrian detection, by sensing road conditions around the vehicle.

The vehicle-mounted camera provided in embodiments of the present disclosure may be mounted on various vehicles, including cars, trucks, buses, hybrid vehicles, pure electric vehicles, or the like.

In yet another aspect, an embodiment of the present disclosure also provides a vehicle, the vehicle being equipped with the vehicle-mounted camera. The vehicle-mounted camera is mounted on a body of the vehicle, and is configured to collect data on a surrounding environment during travelling of the vehicle, so as to facilitate a relevant control module in the vehicle to analyze a current travelling status of the vehicle, such as whether there is any deviation from the lane, a distance from the vehicle in front, or whether a collision may occur.

In yet another aspect, an embodiment of the present disclosure also provides a vehicle, the vehicle including: a windshield; and an optical system according to the above embodiments of the present disclosure, where, the optical system is disposed on an inner side of the windshield, such that the optical system and the windshield form a corrected optical system, and an MTF value of the corrected optical system is within a preset range, enabling good imaging quality.

The foregoing is only a description for preferred embodiments of the present disclosure and the applied technical principles. It should be appreciated by those skilled in the art that the inventive scope of the present disclosure is not limited to the technical solution formed by the particular combination of the above technical features. The inventive scope should also cover other technical solutions formed by any combination of the above technical features or equivalent features thereof without departing from the concept of the present disclosure, for example, technical solutions formed by replacing the features disclosed in embodiments of the present disclosure with (but not limited to) technical features with similar functions.

What is claimed is:

1. An optical system, applied to a vehicle, comprising:
a lens group, comprising a plurality of lenses disposed sequentially along an optical axis from an object side to an image side; and
a compensating lens, at least one of an object-side surface or an image-side surface of the compensating lens being a free-form surface;
wherein, the free-form surface of the compensating lens is adapted to be disposed on an inner side of a windshield of the vehicle, such that the optical system and the windshield form a corrected optical system, and an MTF value of the corrected optical system is within a preset range.

2. The optical system according to claim 1, wherein the MTF value of the corrected optical system for the optical path at the at least one field-of-view in the portion below the optical axis is greater than or equal to 45% @60 lp/mm.

3. The optical system according to claim 1, wherein,
an MTF value of the corrected optical system for optical path at a target field-of-view is greater than an MTF value of the optical system for optical path at the target field-of-view, wherein, the optical path at the target field-of-view is optical path at at least one field-of-view in a portion below the optical axis; or
wherein the MTF value of the corrected optical system for the optical path at the target field-of-view is improved by at least 10%, relative to the MTF value of the optical system for the optical path at the target field-of-view.

4. The optical system according to claim 1, wherein the free-form surface is an upper-lower asymmetric free-form surface.

5. The optical system according to claim 1, wherein the free-form surface is an upper-lower asymmetric and left-right asymmetric free-form surface.

6. The optical system according to claim 1, wherein a maximum thickness d of the compensating lens in a direction parallel to the optical axis, and a length TTL in a direction of the optical axis from a first lens of the lens group to an image plane of the optical system, satisfy: d/TTL≤⅓.

7. The optical system according to claim 1, wherein a direction parallel to the optical axis is defined as a Z-axis direction, a direction perpendicular to the Z-axis and lying in a meridian plane is defined as a Y-axis direction, and a direction perpendicular to the Z-axis and lying in a sagittal plane is defined as an X-axis direction, wherein,
in a YZ plane, the free-form surface of the compensating lens comprises a first area located above the optical axis and a second area located below the optical axis,
an approximate radius of curvature R(+D) of the first area of the free-form surface located above the optical axis and an approximate radius of curvature R(−D) of the second area of the free-form surface located below the optical axis satisfy:
$$0.1 \leq R ( + D ) / R ( - D ) \leq 10.$$

8. The optical system according to claim 7, wherein,
the approximate radius of curvature R(+D) of the first area of the free-form surface located above the optical axis and the approximate radius of curvature R(−D) of the second area of the free-form surface located below the optical axis satisfy:
$$1.1 \leq R ( + D ) / R ( - D ) \leq 10.$$

9. The optical system according to claim 7, wherein, in the YZ plane, a connecting line of effective radius vertices of the free-form surface of the compensating lens located above and below the optical axis has an angle of inclination of less than or equal to 5° relative to a plane perpendicular to the optical axis.

10. The optical system according to claim 7, wherein an approximate radius of curvature Rx in the X-axis direction of the free-form surface in an XZ plane, and an approximate radius of curvature Ry in the Y-axis direction of the free-form surface in the YZ plane, satisfy: Rx/Ry≥0.5.

11. The optical system according to claim 7, wherein an approximate radius of curvature Rx in the X-axis direction of the free-form surface in an XZ plane, and an approximate radius of curvature Ry in the Y-axis direction of the free-form surface in the YZ plane, satisfy: Rx>Ry.

12. The optical system according to claim 7, wherein,
an effective light-gathering diameter D of the free-form surface of the compensating lens, and a maximal aperture T of a lens adjacent to the compensating lens satisfy: D/T≤6;
wherein,
$$D = \sqrt{{Dx}^{2} + {Dy}^{2}} ,$$
Dx is an effective light-gathering diameter of the free-form surface of the compensating lens in the X-axis direction, and Dy is an effective light-gathering diameter of the free-form surface of the compensating lens in the Y-axis direction.

13. The optical system according to claim 1, wherein the plurality of lenses comprise an optical filter and a protective glass.

14. The optical system according to claim 13, wherein the compensating lens is disposed between the optical filter and the protective glass.

15. The optical system according to claim 13, wherein the compensating lens is disposed on an object-side surface or an image-side surface of the optical filter, or is disposed on an object-side surface or an image-side surface of the protective glass.

16. The optical system according to claim 15, wherein the free-form surface of the compensating lens is asymmetrically convex relative to the optical axis.

17. The optical system according to claim 16, wherein the free-form surface of the compensating lens is convex in a half-droplet shape.

18. The optical system according to claim 1, wherein the compensating lens is disposed on an object side or an image side of any one of the lenses in the lens group.

19. The optical system according to claim 1, wherein the compensating lens is prepared through at least one of: nanoimprinting, mould processing, or lamination.

20. The optical system according to claim 1, wherein a maximal aberration value generated by the windshield of the vehicle is L1,
the free-form surface of the compensating lens is configured to: compensate for an astigmatism generated by the windshield of the vehicle, such that a maximal aberration value on the image plane of the corrected optical system is L1′, wherein,
$$L {1}^{′} \leq 1 / 2 L 1.$$

21. The optical system according to claim 1, wherein the optical system satisfies at least one of:
$$d / TTL \leq 0.068 ,$$
$$d / TTL \leq 0.1 ,$$
$$10 \geq R ( + D ) / R ( - D ) \geq 0.6 ,$$
$$5 \geq R ( + D ) / R ( - D ) \geq 1.1 ,$$
$$1 \leq R ( + D ) / R ( - D ) \leq 3.69 ,$$
$$0.5 \leq Rx / Ry \leq 15 ,$$
$$1 \leq Rx / Ry \leq 9.26 ,$$
$$D / T \leq 3 , or$$
$$0.86 \leq D / T \leq 1.85 ,$$
wherein, a direction parallel to the optical axis is defined as a Z-axis direction, a direction perpendicular to the Z-axis and lying in a meridian plane is defined as a Y-axis direction, and a direction perpendicular to the Z-axis and lying in a sagittal plane is defined as an X-axis direction,
in a YZ plane, the free-form surface of the compensating lens comprises a first area located above the optical axis and a second area located below the optical axis, R(+D) is an approximate radius of curvature of the first area located above the optical axis of the free-form surface, R(−D) is an approximate radius of curvature of the second area located below the optical axis of the free-form surface, Rx is an approximate radius of curvature in the X-axis direction of the free-form surface in an XZ plane, Ry is an approximate radius of curvature in the Y-axis direction of the free-form surface in the YZ plane, d is a maximum thickness of the compensating lens in a direction parallel to the optical axis, and TTL is a length in a direction of the optical axis from a first lens of the lens group to an image plane of the optical system.

22. A vehicle-mounted camera, comprising:
an optical system according to claim 1; and
a photosensitive component circuit and a control component, for converting an optical image formed by the optical system into an electrical signal.

23. A vehicle, comprising:
a windshield; and
an optical system according to claim 1, wherein the optical system is disposed on an inner side of the windshield, such that the optical system and the windshield form a corrected optical system.
